(19) United States
(12) Patent Application Publication
(10) Pub. No.: US 2024/0388915 A1
(43) Pub. Date: Nov. 21, 2024

(54) ENHANCED VEHICLE TO EVERYTHING (V2X) CYBERSECURITY CAPABILITIES

(71) Applicant: QUALCOMM Incorporated, San Diego, CA (US)

(72) Inventors: Mohammed Ataur Rahman SHUMAN, San Diego, CA (US); Soumya DAS, San Diego, CA (US); Subrato Kumar DE, San Diego, CA (US)

(21) Appl. No.: 18/664,075

(22) Filed: May 14, 2024

Related U.S. Application Data
(60) Provisional application No. 63/502,625, filed on May 16, 2023.

(51) Int. Cl. H04W 12/121; H04W 4/40

(52) U.S. Cl. CPC H04W 12/121; H04W 4/40

(57) ABSTRACT

Disclosed are systems and techniques for vehicular wireless communications. For example, a process can include receiving a wireless transmission, determining that the wireless transmission includes a first potential threat, generating a first threat report based on the determination that the wireless transmission includes the first potential threat, wherein the first threat report includes information associated with the first potential threat, and transmitting the first threat report to a network node via a vehicular communications system.

### CROSS-REFERENCE TO RELATED APPLICATIONS

This application claims the benefit of U.S. Provisional Patent Application No. 63/502,625, filed May 16, 2023, which is hereby incorporated by reference, in its entirety and for all purposes.

### FIELD

The present disclosure generally relates to vehicle communications. For example, aspects of the present disclosure relate to enhanced cyber security capabilities for vehicle-to-everything (V2X) communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. Aspects of wireless communication may include wireless vehicular communications system that may allow direct communication between devices, such as in V2X, vehicle-to-vehicle (V2V), vehicle-to-pedestrian (V2P), and/or device-to-device (D2D) communication. There exists a need for further improvements in V2X, V2V, V2P, and/or D2D technology. These improvements may also be applicable to other multi-access technologies and the telecommunication standards that employ these technologies.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for threat reporting are provided. In one illustrative example, a vehicular apparatus for threat reporting is provided. The vehicular apparatus includes a memory and a processor coupled to the memory. The processor is configured to: receive a wireless transmission; determine that the wireless transmission includes a first potential threat; generate a first threat report based on the determination that the wireless transmission includes the first potential threat, wherein the first threat report includes information associated with the first potential threat; and transmit the first threat report to a network node via a vehicular communications system.

As another example, a method for threat reporting by a first wireless vehicular device is provided. The method includes receiving a wireless transmission; determining that the wireless transmission includes a first potential threat; generating a first threat report based on the determination that the wireless transmission includes the first potential threat, wherein the first threat report includes information associated with the first potential threat; and transmitting the first threat report to a network node via a vehicular communications system.

In another example, a non-transitory computer-readable medium is provided. The non-transitory computer-readable medium includes instructions that, when executed, cause a processor to receive a wireless transmission; determine that the wireless transmission includes a first potential threat; generate a first threat report based on the determination that the wireless transmission includes the first potential threat, wherein the first threat report includes information associated with the first potential threat; and transmit the first threat report to a network node via a vehicular communications system.

As another example, a vehicular apparatus for threat reporting is provided. The vehicular apparatus includes means for receiving a wireless transmission; means for determining that the wireless transmission includes a first potential threat; means for generating a first threat report based on the determination that the wireless transmission includes the first potential threat, wherein the first threat report includes information associated with the first potential threat; and means for transmitting the first threat report to a network node via a vehicular communications system.

In another example, a method for threat detection by a first wireless vehicular device is provided. The method includes receiving a wireless transmission from a second wireless vehicular device via a vehicular communications system, the wireless transmission including a first threat report, wherein the first threat report includes information associated with a first potential threat, and wherein the first wireless vehicular device is configured to determine whether a received wireless transmission includes a potential threat; and mitigating the first potential threat based on the information associated with the first potential threat.

As another example, a vehicular apparatus for threat detection is provided. The vehicular apparatus includes a memory and a processor coupled to the memory. The processor is configured to: receive a wireless transmission from a second wireless vehicular device via a vehicular communications system, the wireless transmission including a first threat report, wherein the first threat report includes information associated with a first potential threat, and wherein the apparatus is configured to determine whether a received wireless transmission includes a potential threat; and mitigate the first potential threat based on the information associated with the first potential threat.

In another example, a non-transitory computer-readable medium is provided. The non-transitory computer-readable medium includes instructions that, when executed, cause a processor of a first wireless vehicular device to receive a wireless transmission from a second wireless vehicular device via a vehicular communications system, the wireless transmission including a first threat report, wherein the first threat report includes information associated with a first potential threat, and wherein the first wireless vehicular device is configured to determine whether a received wireless transmission includes a potential threat; and mitigate the first potential threat based on the information associated with the first potential threat.

As another example, a vehicular apparatus for threat detection is provided. The vehicular apparatus includes means for receiving a wireless transmission from a second wireless vehicular device via a vehicular communications system, the wireless transmission including a first threat report and wherein the vehicular apparatus is configured to determine whether a received wireless transmission includes a potential threat, wherein the first threat report includes information associated with a first potential threat, and means for mitigating the first potential threat based on the information associated with the first potential threat.

In another example, a method for threat mitigation by a first wireless vehicular device, the method comprising: receiving a threat report from a network node of a vehicular communications system, wherein the threat report includes information associated with a potential threat, and wherein the network node generates the threat report based on a security detection procedure; and mitigating, by the wireless vehicular device, the potential threat based on the information associated with the potential threat without performing the security detection procedure.

As another example, a vehicular apparatus for threat detection is provided. The vehicular apparatus includes a memory and a processor coupled to the memory. The processor is configured to: receive a threat report from a network node of a vehicular communications system, wherein the threat report includes information associated with a potential threat, and wherein the network node generates the threat report based on a security detection procedure; and mitigate the potential threat based on the information associated with the potential threat without performing the security detection procedure.

In another example, a non-transitory computer-readable medium is provided. The non-transitory computer-readable medium includes instructions that, when executed, cause a processor of a wireless vehicular device to receive a threat report from a network node of a vehicular communications system, wherein the threat report includes information associated with a potential threat, and wherein the network node generates the threat report based on a security detection procedure; and mitigate the potential threat based on the information associated with the potential threat without performing the security detection procedure.

As another example, a vehicular apparatus for threat mitigation is provided. The vehicular apparatus including means for receiving a threat report from a network node of a vehicular communications system, wherein the threat report includes information associated with a potential threat, and wherein the network node generates the threat report based on a security detection procedure; and means for mitigating the potential threat based on the information associated with the potential threat without performing the security detection procedure.

In some aspects, the apparatus is, includes, or is part of, a vehicle (e.g., vehicular apparatus, such as an automobile, truck, etc., a component or system of an automobile, truck, etc., or a device coupled to an automobile, truck, etc.), a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a robotics device, or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

This summary is not intended to identify key or essential features of the claimed subject matter, nor is it intended for use in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is a diagram illustrating an example wireless communications system, in accordance with some aspects of the present disclosure.

FIG. 2 is a diagram illustrating an example of a disaggregated base station architecture, which may be employed by the disclosed V2X-sensor misbehavior detection system, in accordance with some aspects of the present disclosure.

FIG. 3 is a diagram illustrating an example of various user equipment (UEs) communicating over direct communication interfaces (e.g., a cellular based PC5 sidelink interface, 802.11p defined DSRC interface, or other direct interface) and wide area network (Uu) interfaces, in accordance with some aspects of the present disclosure.

FIG. 4 is a block diagram illustrating an example of a computing system of a vehicle, in accordance with some aspects of the present disclosure.

FIG. 5 is a block diagram illustrating an example of a computing system of a user device, in accordance with some aspects of the present disclosure.

FIG. 6 illustrates an example of user device having enhanced V2X cybersecurity capabilities, in accordance with aspects of the present disclosure.

FIG. 7 illustrates an example of a wireless network performing a technique for enhanced V2X cybersecurity capabilities, in accordance with aspects of the present disclosure.

FIG. 8 illustrates an example topology of a network for performing a technique for enhanced V2X cybersecurity capabilities, in accordance with aspects of the present disclosure.

FIGS. 9A, 9B, and 9C illustrate details of an example threat report, in accordance with aspects of the present disclosure.

FIG. 10 is a flow diagram of a process for threat reporting for a wireless vehicular device, in accordance with aspects of the present disclosure.

FIG. 11 is a flow diagram of a process for threat reporting for a wireless vehicular device, in accordance with aspects of the present disclosure.

FIG. 12 is a flow diagram of a process for threat detection for a wireless device, in accordance with aspects of the present disclosure.

FIG. 13 illustrates an example computing system, according to aspects of the disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communications systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

Vehicles are an example of systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems encompass vehicle-to-vehicle (V2V), vehicle-to-infrastructure (V2I), vehicle-to-network (V2N), and vehicle-to-pedestrian (V2P) communications, LTE-V2X, NR-V2X, C-V2X, etc., which are all collectively referred to as vehicle-to-everything (V2X) communications. V2X communications is a vehicular communications system that supports the wireless transfer of information from a vehicle to other entities (e.g., other vehicles, pedestrians with smart phones, equipped vulnerable road users (VRUs), such as bicyclists, and/or other traffic infrastructure) located within the traffic system that may affect the vehicle. The main purpose of the V2X technology is to improve road safety, fuel savings, and traffic efficiency.

In a V2X communication system, information is transmitted from vehicle sensors (and other sources) through wireless links to allow the information to be communicated to other vehicles, pedestrians, VRUs, and/or traffic infrastructure. The information may be transmitted using one or more vehicle-based messages, such as cellular-vehicle-to-everything (C-V2X) messages, which can include Sensor Data Sharing Messages (SDSMs), Basic Safety Messages (BSMs), Cooperative Awareness Messages (CAMs), Collective Perception Messages (CPMs), Decentralized Environmental Messages (DENMs), and/or other types of vehicle-based messages. By sharing this information with other vehicles, the V2X technology improves vehicle (and driver) awareness of potential dangers to help reduce collisions with other vehicles and entities. In addition, the V2X technology enhances traffic efficiency by providing traffic warnings to vehicles of potential upcoming road dangers and obstacles such that vehicles may choose alternative traffic routes.

As previously mentioned, the V2X technology includes V2V communications and vehicle-to-pedestrian (V2P) communications, which can also be referred to as peer-to-peer communications. V2V communications allows for vehicles to directly wireless communicate with each other while on the road. V2P communications allows for vehicles to directly wireless communicate with pedestrian devices, such as UEs. With V2V and V2P communications, vehicles can gain situational awareness by receiving information regarding upcoming road dangers (e.g., unforeseen oncoming vehicles, accidents, and road conditions) from the other vehicles and/or pedestrian devices.

Recently, security for ADAS systems has becomes more important as more advanced ADAS systems become available and become increasingly relied upon. One security concern involves over the air (OTA) attacks where an attacker may attempt to transmit messages to attack wireless devices, such as UEs (e.g., ADAS systems). Classes of attacks that may be OTA attacks may include international mobile subscriber identity stealing, cell phone jamming, denial of service, spamming or phishing text messages, fake emergency broadcasts, man-in-the-middle attacks, attempts to steal credentials, tracking a location of a wireless device, and fake access points. Some ADAS systems may include security features which allow the ADAS system to detect and/or protect against OTA attacks. For example, an ADAS system may detect a fake access point based on a receiving multiple paging messages indicating a modification to system information. However, not all ADAS systems may include OTA attack detection systems and it may be useful to provide some waring to ADAS systems that may not include OTA attacked detection systems. Additionally, it may be advantageous for ADAS systems with OTA attack detection systems to receive a warning of possible attacks.

Systems, apparatuses (e.g., network devices), methods (also referred to as processes), and computer-readable media (collectively referred to herein as “systems and techniques”) are provided for enhanced V2X cybersecurity capabilities. The systems and techniques can allow a UE (e.g., implementing an ADAS system supporting V2X communications), to detect potential threats, generate threat reports, and transmit such threat reports to other wireless vehicular devices, such as network nodes or other UEs. In some cases, the threat report may include information associated with the threat. For example, a threat report can include location and time information indicating where and when a potential threat is detected. The threat report may also include information about the threat (e.g., information characterizing or describing the threat), a category associated with the potential threat, confidence information, and/or a threat score. In some cases, the threat report may be broadcast for reception by other wireless vehicular devices.

Where the threat report is received by another UE, the other UE may take steps to mitigate the potential threat. For example, the other UE may change a route of the other UE to avoid the potential threat, block a wireless station associated with the potential threat, and/or use the threat report as a part of generating another threat report. As an example of using the threat report as a part of generating another threat report, the other UE capable of detecting OTA attacks may use information in the threat report to help determine if the other UE has also detected the potential OTA attack (e.g., based on an identifier in the threat report). The other UE may then indicate, in its own threat report, that the UE detected the threat and received a corroborating threat report.

In some aspects, the threat report may be received by a network node. In some cases, the network node may be a road-side unit (RSU). The RSU may transmit the threat report to a traffic management center (TMC), which may aggregate the threat reports. The aggregated threat reports may be passed to other consumers of the threat reports, such as local law enforcement, network providers, and the like. The aggregated reports may also be passed to other UEs, for example, via the RSUs. In some cases, the threat reports may also be passed to an Internet-based server, instead of a TMC. The Internet-based server may then perform actions substantially similar to the TMC.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “wireless vehicular device”, a “vehicular apparatus,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, road side units (RSUs), and/or other devices depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

A roadside unit (RSU) is a device that can transmit and receive messages over a communications link or interface (e.g., a cellular-based sidelink or PC5 interface, an 802.11 or WiFi™ based Dedicated Short Range Communication (DSRC) interface, and/or other interface) to and from one or more UEs, other RSUs, and/or base stations. An example of messages that can be transmitted and received by an RSU includes vehicle-to-everything (V2X) messages, which are described in more detail below. RSUs can be located on various transportation infrastructure systems, including roads, bridges, parking lots, toll booths, and/or other infrastructure systems. In some examples, an RSU can facilitate communication between UEs (e.g., vehicles, pedestrian user devices, and/or other UEs) and the transportation infrastructure systems. In some implementations, a RSU can be in communication with a server, base station, and/or other system that can perform centralized management functions.

An RSU can communicate with a communications system of a UE. For example, an intelligent transport system (ITS) of a UE (e.g., a vehicle and/or other UE) can be used to generate and sign messages for transmission to an RSU and to validate messages received from an RSU. An RSU can communicate (e.g., over a PC5 interface, DSRC interface, etc.) with vehicles traveling along a road, bridge, or other infrastructure system in order to obtain traffic-related data (e.g., time, speed, location, etc. of the vehicle). In some cases, in response to obtaining the traffic-related data, the RSU can determine or estimate traffic congestion information (e.g., a start of traffic congestion, an end of traffic congestion, etc.), a travel time, and/or other information for a particular location. In some examples, the RSU can communicate with other RSUs (e.g., over a PC5 interface, DSRC interface, etc.) in order to determine the traffic-related data. The RSU can transmit the information (e.g., traffic congestion information, travel time information, and/or other information) to other vehicles, pedestrian UEs, and/or other UEs. For example, the RSU can broadcast or otherwise transmit the information to any UE (e.g., vehicle, pedestrian UE, etc.) that is in a coverage range of the RSU.

A radio frequency signal or “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

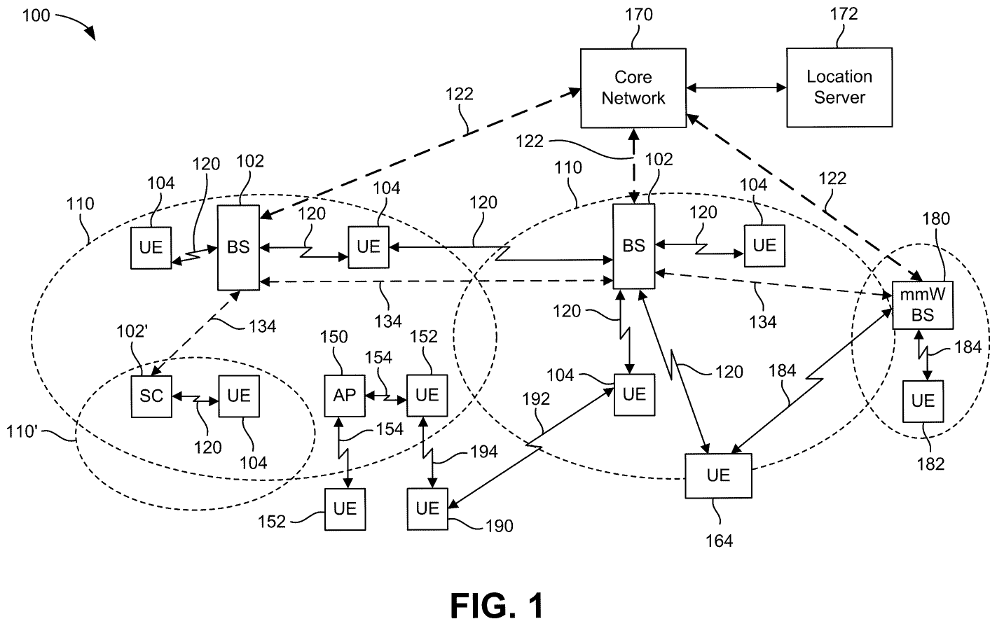

According to various aspects, FIG. 1 illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHZ), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHZ) bandwidth per carrier up to a total of Yx MHZ (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

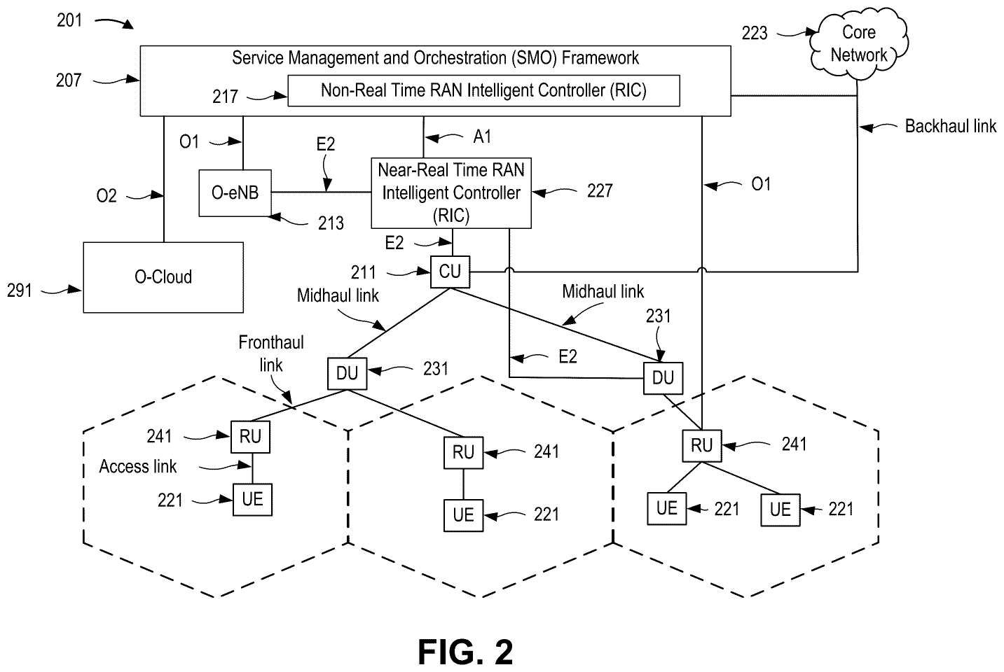

FIG. 2 is a diagram illustrating an example of a disaggregated base station architecture, which may be employed by the disclosed V2X-sensor misbehavior detection system, in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2 is a diagram illustrating an example of a disaggregated base station architecture, which may be employed by the disclosed V2X-sensor misbehavior detection system, in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 201 architecture. The disaggregated base station 201 architecture may include one or more central units (CUs) 211 that can communicate directly with a core network 223 via a backhaul link, or indirectly with the core network 223 through one or more disaggregated base station units (such as a Near-Real Time (Near-RT) RAN Intelligent Controller (RIC) 227 via an E2 link, or a Non-Real Time (Non-RT) RIC 217 associated with a Service Management and Orchestration (SMO) Framework 207, or both). A CU 211 may communicate with one or more distributed units (DUs) 231 via respective midhaul links, such as an F1 interface. The DUs 231 may communicate with one or more radio units (RUs) 241 via respective fronthaul links. The RUs 241 may communicate with respective UEs 221 via one or more RF access links. In some implementations, the UE 221 may be simultaneously served by multiple RUs 241.

Each of the units, i.e., the CUS 211, the DUs 231, the RUs 241, as well as the Near-RT RICs 227, the Non-RT RICs 217 and the SMO Framework 207, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211. The CU 211 may be configured to handle user plane functionality (i.e., Central Unit-User Plane (CU-UP)), control plane functionality (i.e., Central Unit-Control Plane (CU-CP)), or a combination thereof. In some implementations, the CU 211 can be logically split into one or more CU-UP units and one or more CU-CP units. The CU-UP unit can communicate bidirectionally with the CU-CP unit via an interface, such as the E1 interface when implemented in an O-RAN configuration. The CU 211 can be implemented to communicate with the DU 131, as necessary, for network control and signaling.

The DU 231 may correspond to a logical unit that includes one or more base station functions to control the operation of one or more RUs 241. In some aspects, the DU 231 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 231 may further host one or more low PHY layers. Each layer (or module) can be implemented with an interface configured to communicate signals with other layers (and modules) hosted by the DU 231, or with the control functions hosted by the CU 211.

Lower-layer functionality can be implemented by one or more RUs 241. In some deployments, an RU 241, controlled by a DU 231, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 241 can be implemented to handle over the air (OTA) communication with one or more UEs 221. In some implementations, real-time and non-real-time aspects of control and user plane communication with the RU(s) 241 can be controlled by the corresponding DU 231. In some scenarios, this configuration can enable the DU(s) 231 and the CU 211 to be implemented in a cloud-based RAN architecture, such as a vRAN architecture.

The SMO Framework 207 may be configured to support RAN deployment and provisioning of non-virtualized and virtualized network elements. For non-virtualized network elements, the SMO Framework 207 may be configured to support the deployment of dedicated physical resources for RAN coverage requirements which may be managed via an operations and maintenance interface (such as an O1 interface). For virtualized network elements, the SMO Framework 207 may be configured to interact with a cloud computing platform (such as an open cloud (O-Cloud) 291) to perform network element life cycle management (such as to instantiate virtualized network elements) via a cloud computing platform interface (such as an O2 interface). Such virtualized network elements can include, but are not limited to, CUs 211, DUs 231, RUs 241 and Near-RT RICs 227. In some implementations, the SMO Framework 207 can communicate with a hardware aspect of a 4G RAN, such as an open eNB (O-eNB) 213, via an O1 interface. Additionally, in some implementations, the SMO Framework 207 can communicate directly with one or more RUs 241 via an O1 interface. The SMO Framework 207 also may include a Non-RT RIC 217 configured to support functionality of the SMO Framework 207.

The Non-RT RIC 217 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The Non-RT RIC 217 may be coupled to or communicate with (such as via an A1 interface) the Near-RT RIC 227. The Near-RT RIC 227 may be configured to include a logical function that enables near-real-time control and optimization of RAN elements and resources via data collection and actions over an interface (such as via an E2 interface) connecting one or more CUs 211, one or more DUs 231, or both, as well as an O-eNB 213, with the Near-RT RIC 227.

In some implementations, to generate AI/ML models to be deployed in the Near-RT RIC 227, the Non-RT RIC 217 may receive parameters or external enrichment information from external servers. Such information may be utilized by the Near-RT RIC 227 and may be received at the SMO Framework 207 or the Non-RT RIC 217 from non-network data sources or from network functions. In some examples, the Non-RT RIC 217 or the Near-RT RIC 227 may be configured to tune RAN behavior or performance. For example, the Non-RT RIC 217 may monitor long-term trends and patterns for performance and employ AI/ML models to perform corrective actions through the SMO Framework 207 (such as reconfiguration via 01) or via creation of RAN management policies (such as A1 policies).

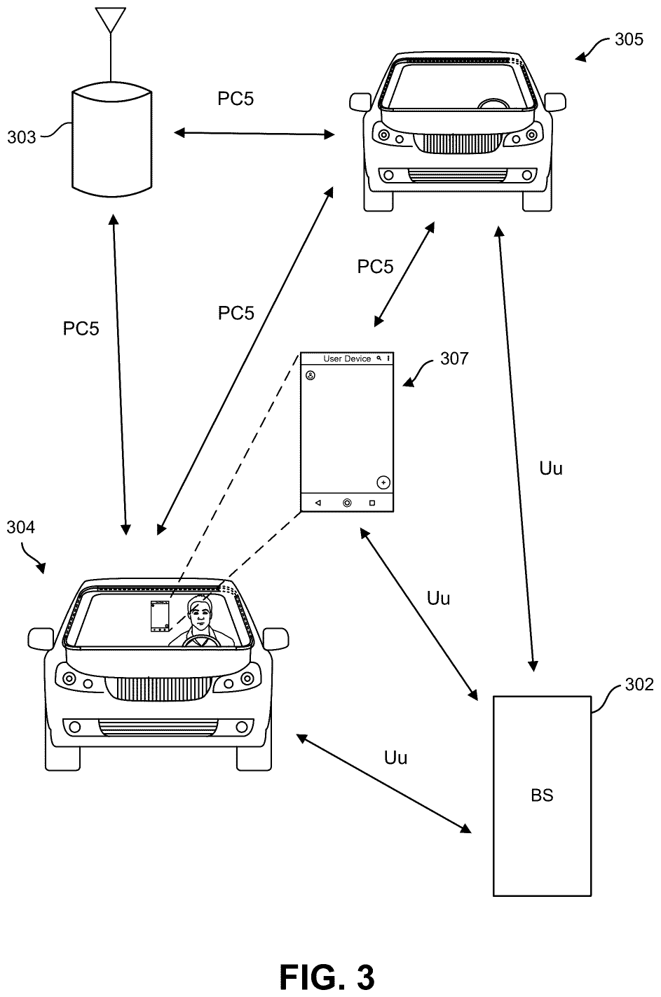

FIG. 3 illustrates examples of different communication mechanisms used by various UEs. In one example of sidelink communications, FIG. 3 illustrates a vehicle 304, a vehicle 305, and an RSU 303 communicating with each other using PC5, DSRC, or other device to device direct signaling interfaces. In addition, the vehicle 304 and the vehicle 305 may communicate with a base station 302 (shown as BS 302) using a network (Uu) interface. The base station 302 can include a gNB in some examples. FIG. 3 also illustrates a user device 307 communicating with the base station 302 using a network (Uu) interface. As described below, functionalities can be transferred from a vehicle (e.g., vehicle 304) to a user device (e.g., user device 307) based on one or more characteristics or factors (e.g., temperature, humidity, etc.). In one illustrative example, V2X functionality can be transitioned from the vehicle 304 to the user device 307, after which the user device 307 can communicate with other vehicles (e.g., vehicle 305) over a PC5 interface (or other device to device direct interface, such as a DSRC interface), as shown in FIG. 3.

While FIG. 3 illustrates a particular number of vehicles (e.g., two vehicles 304 and 305) communicating with each other and/or with RSU 303, BS 302, and/or user device 307, the present disclosure is not limited thereto. For instance, tens or hundreds of such vehicles may be communicating with one another and/or with RSU 303, BS 302, and/or user device 307. At any given point in time, each such vehicle, RSU 303, BS 302, and/or user device 307 may transmit various types of information as messages to other nearby vehicles resulting in each vehicle (e.g., vehicles 304 and/or 305), RSU 303, BS 302, and/or user device 307 receiving hundreds or thousands of messages from other nearby vehicles, RSUs, base stations, and/or other UEs per second.

While PC5 interfaces are shown in FIG. 3, the various UEs (e.g., vehicles, user devices, etc.) and RSU(s) can communicate directly using any suitable type of direct interface, such as an 802.11 DSRC interface, a Bluetooth™ interface, and/or other interface. For example, a vehicle can communicate with a user device over a direct communications interface (e.g., using PC5 and/or DSRC), a vehicle can communicate with another vehicle over the direct communications interface, a user device can communicate with another user device over the direct communications interface, a UE (e.g., a vehicle, user device, etc.) can communicate with an RSU over the direct communications interface, an RSU can communicate with another RSU over the direct communications interface, and the like.

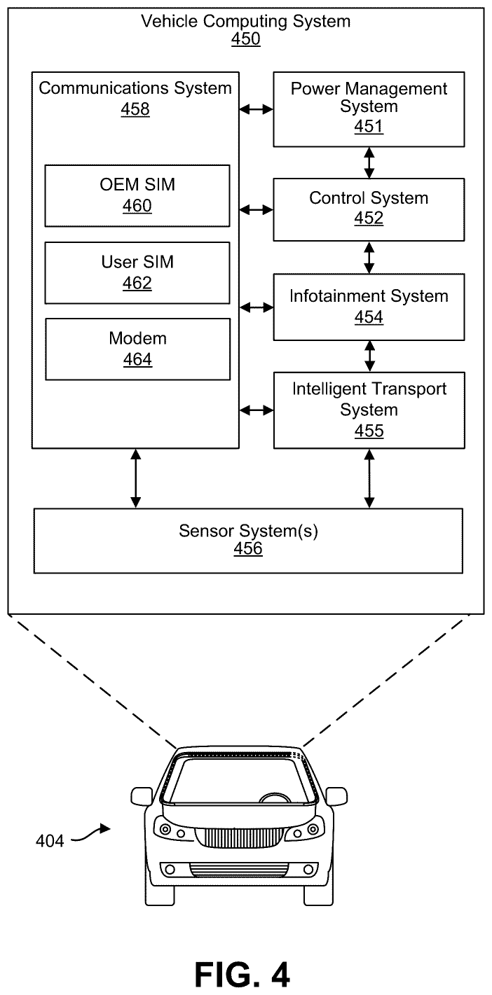

FIG. 4 is a block diagram illustrating an example a vehicle computing system 450 of a vehicle 404. The vehicle 404 is an example of a UE that can communicate with a network (e.g., an eNB, a gNB, a positioning beacon, a location measurement unit, and/or other network entity) over a Uu interface and with other UEs using V2X communications over a PC5 interface (or other device to device direct interface, such as a DSRC interface). As shown, the vehicle computing system 450 can include at least a power management system 451, a control system 452, an infotainment system 454, an intelligent transport system (ITS) 455, one or more sensor systems 456, and a communications system 458. In some cases, the vehicle computing system 450 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 452 can be configured to control one or more operations of the vehicle 404, the power management system 451, the computing system 450, the infotainment system 454, the ITS 455, and/or one or more other systems of the vehicle 404 (e.g., a braking system, a steering system, a safety system other than the ITS 455, a cabin system, and/or other system). In some examples, the control system 452 can include one or more electronic control units (ECUs). An ECU can control one or more of the electrical systems or subsystems in a vehicle. Examples of specific ECUs that can be included as part of the control system 452 include an engine control module (ECM), a powertrain control module (PCM), a transmission control module (TCM), a brake control module (BCM), a central control module (CCM), a central timing module (CTM), among others. In some cases, the control system 452 can receive sensor signals from the one or more sensor systems 456 and can communicate with other systems of the vehicle computing system 450 to operate the vehicle 404.

The vehicle computing system 450 also includes a power management system 451. In some implementations, the power management system 451 can include a power management integrated circuit (PMIC), a standby battery, and/or other components. In some cases, other systems of the vehicle computing system 450 can include one or more PMICs, batteries, and/or other components. The power management system 451 can perform power management functions for the vehicle 404, such as managing a power supply for the computing system 450 and/or other parts of the vehicle. For example, the power management system 451 can provide a stable power supply in view of power fluctuations, such as based on starting an engine of the vehicle. In another example, the power management system 451 can perform thermal monitoring operations, such as by checking ambient and/or transistor junction temperatures. In another example, the power management system 451 can perform certain functions based on detecting a certain temperature level, such as causing a cooling system (e.g., one or more fans, an air conditioning system, etc.) to cool certain components of the vehicle computing system 450 (e.g., the control system 452, such as one or more ECUs), shutting down certain functionalities of the vehicle computing system 450 (e.g., limiting the infotainment system 454, such as by shutting off one or more displays, disconnecting from a wireless network, etc.), among other functions.

The vehicle computing system 450 further includes a communications system 458. The communications system 458 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 458 is configured to transmit and receive information wirelessly over any suitable wireless network (e.g., a 3G network, 4G network, 5G network, WiFi network, Bluetooth™ network, and/or other network). The communications system 458 includes various components or devices used to perform the wireless communication functionalities, including an original equipment manufacturer (OEM) subscriber identity module (referred to as a SIM or SIM card) 460, a user SIM 462, and a modem 464. While the vehicle computing system 450 is shown as having two SIMs and one modem, the computing system 450 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 460 can be used by the communications system 458 for establishing a wireless connection for vehicle-based operations, such as for conducting emergency-calling (cCall) functions, communicating with a communications system of the vehicle manufacturer (e.g., for software updates, etc.), among other operations. The OEM SIM 460 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 462 can be used by the communications system 458 for performing wireless network access functions in order to support a user data connection (e.g., for conducting phone calls, messaging, Infotainment related services, among others). In some cases, a user device of a user can connect with the vehicle computing system 450 over an interface (e.g., over PC5, Bluetooth™, WiFI™ (e.g., DSRC), a universal serial bus (USB) port, and/or other wireless or wired interface). Once connected, the user device can transfer wireless network access functionality from the user device to communications system 458 the vehicle, in which case the user device can cease performance of the wireless network access functionality (e.g., during the period in which the communications system 458 is performing the wireless access functionality). The communications system 458 can begin interacting with a base station to perform one or more wireless communication operations, such as facilitating a phone call, transmitting and/or receiving data (e.g., messaging, video, audio, etc.), among other operations. In such cases, other components of the vehicle computing system 450 can be used to output data received by the communications system 458. For example, the infotainment system 454 (described below) can display video received by the communications system 458 on one or more displays and/or can output audio received by the communications system 458 using one or more speakers.

A modem is a device that modulates one or more carrier wave signals to encode digital information for transmission, and demodulates signals to decode the transmitted information. The modem 464 (and/or one or more other modems of the communications system 458) can be used for communication of data for the OEM SIM 460 and/or the user SIM 462. In some examples, the modem 464 can include a 4G (or LTE) modem and another modem (not shown) of the communications system 458 can include a 5G (or NR) modem. In some examples, the communications system 458 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 464 (and/or one or more other modems of the communications system 458) can be used for performing V2X communications (e.g., with other vehicles for V2V communications, with other devices for D2D communications, with infrastructure systems for V2I communications, with pedestrian UEs for V2P communications, etc.). In some examples, the communications system 458 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 458 can be or can include a telematics control unit (TCU). In some implementations, the TCU can include a network access device (NAD) (also referred to in some cases as a network control unit or NCU). The NAD can include the modem 464, any other modem not shown in FIG. 4, the OEM SIM 460, the user SIM 462, and/or other components used for wireless communications. In some examples, the communications system 458 can include a Global Navigation Satellite System (GNSS). In some cases, the GNSS can be part of the one or more sensor systems 456, as described below. The GNSS can provide the ability for the vehicle computing system 450 to perform one or more location services, navigation services, and/or other services that can utilize GNSS functionality.

In some cases, the communications system 458 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 404 to communicate with a network and/or other UEs.

The vehicle computing system 450 can also include an infotainment system 454 that can control content and one or more output devices of the vehicle 404 that can be used to output the content. The infotainment system 454 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 404), and/or other output device.

In some examples, the computing system 450 can include the intelligent transport system (ITS) 455. In some examples, the ITS 455 can be used for implementing V2X communications. For example, an ITS stack of the ITS 455 can generate V2X messages based on information from an application layer of the ITS. In some cases, the application layer can determine whether certain conditions have been met for generating messages for use by the ITS 455 and/or for generating messages that are to be sent to other vehicles (for V2V communications), to pedestrian UEs (for V2P communications), and/or to infrastructure systems (for V2I communications). In some cases, the communications system 458 and/or the ITS 455 can obtain car access network (CAN) information (e.g., from other components of the vehicle via a CAN bus). In some examples, the communications system 458 (e.g., a TCU NAD) can obtain the CAN information via the CAN bus and can send the CAN information to a PHY/MAC layer of the ITS 455. The ITS 455 can provide the CAN information to the ITS stack of the ITS 455. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 455.

The conditions used to determine whether to generate messages can be determined using the CAN information based on safety-related applications and/or other applications, including applications related to road safety, traffic efficiency, infotainment, business, and/or other applications. In one illustrative example, the ITS 455 can perform lane change assistance or negotiation. For instance, using the CAN information, the ITS 455 can determine that a driver of the vehicle 404 is attempting to change lanes from a current lane to an adjacent lane (e.g., based on a blinker being activated, based on the user vecring or steering into an adjacent lane, etc.). Based on determining the vehicle 404 is attempting to change lanes, the ITS 455 can determine a lane-change condition has been met that is associated with a message to be sent to other vehicles that are nearby the vehicle (e.g., in the adjacent lane, within a threshold distance, such as ten feet, fifteen feet, or other distance, or otherwise nearby the vehicle). The ITS 455 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 404, such as based on V2P communications with a UE of the user), traffic sign recognition, among others.

The ITS 455 can use any suitable protocol to generate messages (e.g., V2X messages). Examples of protocols that can be used by the ITS 455 include one or more Society of Automotive Engineering (SAE) standards, such as SAE J2735, SAE J2945, SAE J3161, and/or other standards, which are hereby incorporated by reference in their entirety and for all purposes.

A security layer of the ITS 455 can be used to securely sign messages from the ITS stack that are sent to and verified by other UEs configured for V2X communications, such as other vehicles, pedestrian UEs, and/or infrastructure systems. The security layer can also verify messages received from such other UEs. In some implementations, the signing and verification processes can be based on a security context of the vehicle. In some examples, the security context may include one or more encryption-decryption algorithms, a public and/or private key used to generate a signature using an encryption-decryption algorithm, and/or other information. For example, each ITS message generated by the ITS 455 can be signed by the security layer of the ITS 455. The signature can be derived using a public key and an encryption-decryption algorithm. A vehicle, pedestrian UE, and/or infrastructure system receiving a signed message can verify the signature to make sure the message is from an authorized vehicle. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 455 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 452) to perform automatic functions, such as automatic breaking, automatic steering (e.g., to maintain a heading in a particular lane), automatic lane change negotiation with other vehicles, among other automatic functions. In one illustrative example, a message can be received by the communications system 458 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 452, which can cause the control system 452 to automatically break the vehicle 404 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 455 can receive a large number of messages from the other UEs (e.g., vehicles, RSUs, etc.), in which case the ITS 455 will authenticate (e.g., decode and decrypt) each of the messages and/or determine which operations to perform. Such a large number of messages can lead to a large computational load for the vehicle computing system 450. In some cases, the large computational load can cause a temperature of the computing system 450 to increase. Rising temperatures of the components of the computing system 450 can adversely affect the ability of the computing system 450 to process the large number of incoming messages. One or more functionalities can be transitioned from the vehicle 404 to another device (e.g., a user device, a RSU, etc.) based on a temperature of the vehicle computing system 450 (or component thereof) exceeding or approaching one or more thermal levels. Transitioning the one or more functionalities can reduce the computational load on the vehicle 404, helping to reduce the temperature of the components. A thermal load balancer can be provided that enable the vehicle computing system 450 to perform thermal based load balancing to control a processing load depending on the temperature of the computing system 450 and processing capacity of the vehicle computing system 450.

The computing system 450 further includes one or more sensor systems 456 (e.g., a first sensor system through an Nth sensor system, where N is a value equal to or greater than 0). When including multiple sensor systems, the sensor system(s) 456 can include different types of sensor systems that can be arranged on or in different parts the vehicle 404. The sensor system(s) 456 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 450 of the vehicle 404.

While the vehicle computing system 450 is shown to include certain components and/or systems, one of ordinary skill will appreciate that the vehicle computing system 450 can include more or fewer components than those shown in FIG. 4. For example, the vehicle computing system 450 can also include one or more input devices and one or more output devices (not shown). In some implementations, the vehicle computing system 450 can also include (e.g., as part of or separate from the control system 452, the infotainment system 454, the communications system 458, and/or the sensor system(s) 456) at least one processor and at least one memory having computer-executable instructions that are executed by the at least one processor. The at least one processor is in communication with and/or electrically connected to (referred to as being “coupled to” or “communicatively coupled”) the at least one memory. The at least one processor can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein.

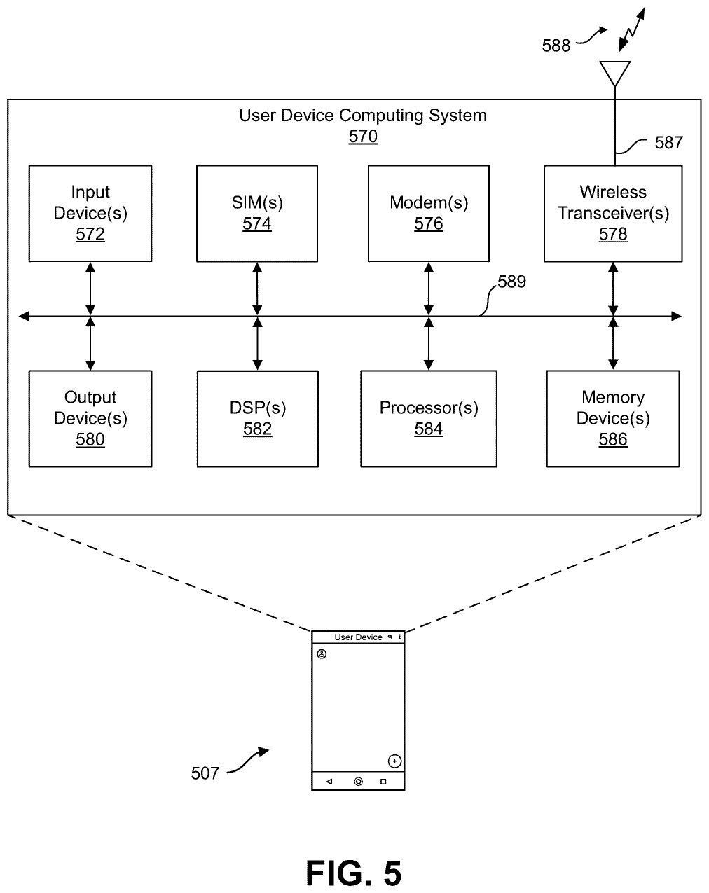

FIG. 5 illustrates an example of a computing system 570 of a user device 507. The user device 507 is an example of a UE that can be used by an end-user. For example, the user device 507 can include a mobile phone, router, tablet computer, laptop computer, tracking device, wearable device (e.g., a smart watch, glasses, an XR device, etc.), Internet of Things (IoT) device, and/or other device used by a user to communicate over a wireless communications network. The computing system 570 includes software and hardware components that can be electrically or communicatively coupled via a bus 589 (or may otherwise be in communication, as appropriate). For example, the computing system 570 includes one or more processors 584. The one or more processors 584 can include one or more CPUs, ASICS, FPGAs, APs, GPUs, VPUs, NSPs, microcontrollers, dedicated hardware, any combination thereof, and/or other processing device or system. The bus 589 can be used by the one or more processors 584 to communicate between cores and/or with the one or more memory devices 586.

The computing system 570 may also include one or more memory devices 586, one or more digital signal processors (DSPs) 582, one or more SIMs 574, one or more modems 576, one or more wireless transceivers 578, an antenna 587, one or more input devices 572 (e.g., a camera, a mouse, a keyboard, a touch sensitive screen, a touch pad, a keypad, a microphone, and/or the like), and one or more output devices 580 (e.g., a display, a speaker, a printer, and/or the like).

The one or more wireless transceivers 578 can receive wireless signals (e.g., wireless signal 588) via antenna 587 from one or more other devices, such as other user devices, vehicles (e.g., vehicle 404 of FIG. 4 described above), network devices (e.g., base stations such as eNBs and/or gNBs, WiFI routers, etc.), cloud networks, and/or the like. In some examples, the computing system 570 can include multiple antennae. The wireless signal 588 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 578 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 588 into a baseband or intermediate frequency and can convert the RF signals to the digital domain.

In some cases, the computing system 570 can include a coding-decoding device (or CODEC) configured to encode and/or decode data transmitted and/or received using the one or more wireless transceivers 578. In some cases, the computing system 570 can include an encryption-decryption device or component configured to encrypt and/or decrypt data (e.g., according to the AES and/or DES standard) transmitted and/or received by the one or more wireless transceivers 578.

The one or more SIMs 574 can each securely store an IMSI number and related key assigned to the user of the user device 507. As noted above, the IMSI and key can be used to identify and authenticate the subscriber when accessing a network provided by a network service provider or operator associated with the one or more SIMs 574. The one or more modems 576 can modulate one or more signals to encode information for transmission using the one or more wireless transceivers 578. The one or more modems 576 can also demodulate signals received by the one or more wireless transceivers 578 in order to decode the transmitted information. In some examples, the one or more modems 576 can include a 4G (or LTE) modem, a 5G (or NR) modem, a modem configured for V2X communications, and/or other types of modems. The one or more modems 576 and the one or more wireless transceivers 578 can be used for communicating data for the one or more SIMs 574.

The computing system 570 can also include (and/or be in communication with) one or more non-transitory machine-readable storage media or storage devices (e.g., one or more memory devices 586), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 586 and executed by the one or more processor(s) 584 and/or the one or more DSPs 582. The computing system 570 can also include software elements (e.g., located within the one or more memory devices 586), including, for example, an operating system, device drivers, executable libraries, and/or other code, such as one or more application programs, such as a V2X application, which may comprise computer programs implementing the functions provided by various aspects, and/or may be designed to implement methods and/or configure systems, as described herein.

In some cases, advanced driver assistance systems (ADAS) for vehicles may be networked to allow vehicles to communicate with each other and with roadside systems. This networking may help provide increased safety and efficiency as vehicles may exchange information about road conditions or coordinate to allow for smoother traffic flows. As more advanced ADAS systems become available and relied upon, security for ADAS systems becomes more important. One security concern involves potential over the air (OTA) attacks where an attacker may attempt to transmit messages to attack wireless devices, such as UEs (e.g., vehicles, wireless vehicular devices configured to perform V2X communications, etc.). In some cases, OTA attacks may include international mobile subscriber identity (IMSI) stealing, jamming, denial of service, spamming or phishing text messages, fake emergency broadcasts, man-in-the-middle attacks, attempts to steal credentials, tracking a location of a wireless vehicular device, fake access points, some combination thereof, etc. In some cases, certain ADAS systems may include security features which allow the ADAS system to detect and/or protect against OTA attacks. For example, the ADAS system may detect a fake access point based on receiving multiple paging messages indicating a modification to system information.

As ADAS systems become more popular, different vehicles may include different ADAS systems with varying capabilities. For example, some vehicles may include ADAS systems which may be able to detect OTA attacks, while other vehicles may not be able to detect OTA attacks. In some cases, it may be useful to allow vehicles to share information about detected OTA attacks. For example, sharing information about detected OTA attacks may allow for an increased awareness of such attacks, which may help prevent or mitigate damage caused by such attacks.

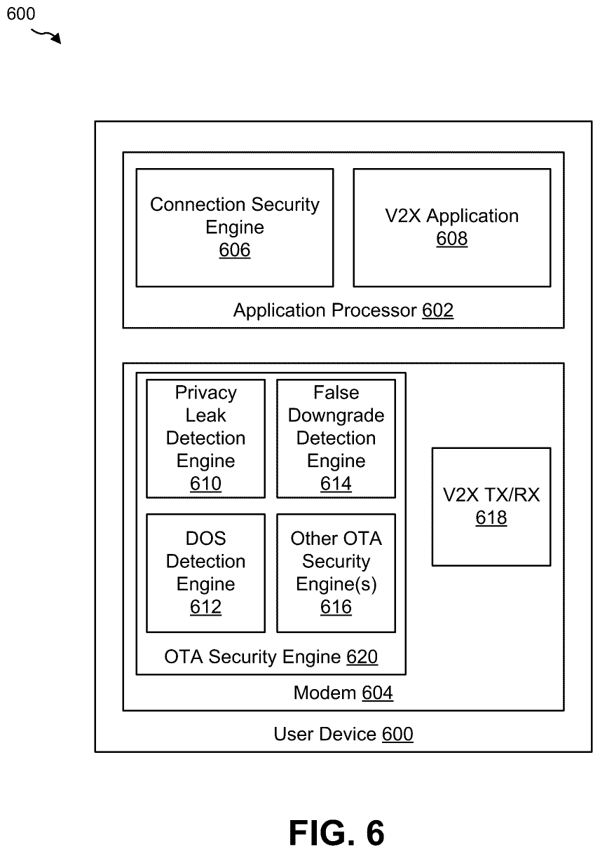

FIG. 6 illustrates an example of user device 600 having enhanced V2X cybersecurity capabilities, in accordance with aspects of the present disclosure. In this simplified example, user device 600 includes an application processor 602 and a modem 604. The modem 604 includes a V2X transceiver 618 which may send and receive V2X messages and an OTA security engine 620 for detecting and/or mitigating possible OTA attacks via a security detection and/or mitigation procedure. The security detection procedure may be a procedure for detecting potential threats in a wireless transmission. In some cases, the V2X messages may be cellular based (e.g., C-V2X, sidelink, and the like), Wi-Fi based, dedicated short-ranged communications (DSRC) based, and the like. Transmissions received by the V2X transceiver 618 may be analyzed by an OTA security engine 620 for potential OTA security issues (e.g., potential threats). The OTA security engine 620 may detect a variety of potential threats. For example, the OTA security engine 620 may include a privacy leak detection engine 610, a denial of service (DOS) detection engine 612, a false downgrade detection engine 614, and/or other OTA security engine(s) 616. In some cases, the privacy leak detection engine 610 may detect attempts to steal credentials and/or spam/phishing text message. The DOS detection engine 612 may attempt to detect DOS attacks against the user device 600. The false downgrade detection engine 614 may attempt to detect attempts to downgrade a first radio access technology (RAT) to a second RAT that may be less secure, such as from a 5G RAT to a 4G RAT. The other OTA security engine(s) 616 may include security engines, such as ones to detect false access points, tracking attempts, and the like.

If the OTA security engine 620 determines there is a potential threat from a received wireless transmission, the OTA security engine 620 may send an indication of the potential threat to a connection security engine 606. In some cases, the connection security engine 606 may be an application executing on the application processor 602. For example, the OTA security engine 620 may pass a detection report to the connection security engine 606. The detection report may indicate whether the potential threat may be occurring/has occurred. The connection security engine 606 may pass the detection report to a V2X application 608 executing on the application processor 602. For example, the V2X application 608 may subscribe to detection reports from the connection security engine 606 to receive the detection report(s) generated by OTA security engine 620. In some cases, periodic detection reports may be provided to the V2X application 608. In other cases, detection reports may be provided to the V2X application 608 when potential threats are detected. In some cases, the detection report may include an indication of a time a potential threat was detected and location information of the user device 600 when the potentiation threat was detected in the detection report. The time and location report may be provided for the detection report as a whole, or for certain potential threats in the detection report. Of note, while shown as two separate applications (or a part of two different applications) in this example, it may be understood that the connection security engine 606 and the V2X application 608 may be integrated into a single application executing on the application processor 602.

In some cases, the V2X application 608 may generate a threat report (e.g., cyber_security_threat_report) based on the detection report and wirelessly transmit the threat report to a wireless network via V2X transceiver 618. In some cases, the threat report may be wirelessly transmitted as a broadcast. The threat report may be sent either periodically or after a potential threat is detected/mitigated. The threat report may be sent as a part of another message. For example, the threat report may be added as an optional field to a basic safety message (BSM) as defined in SAE J2945, SAE J3161, and/or SAE J2735. As another example, the threat report may be added as an optional field to a sensor data sharing message (SDSM) as defined in SAE J3224. In other cases, the threat report may be added to other messages, such as a traveler information message (TIM) or road side message (RSM). In some cases, a new message may be defined for the threat report. In some cases, threat reports may be associated with (e.g., include an indication of) a time that an attack was detected (or time a wireless transmission including the potential threat was received) and a location of the user device 600 when the attack occurred.

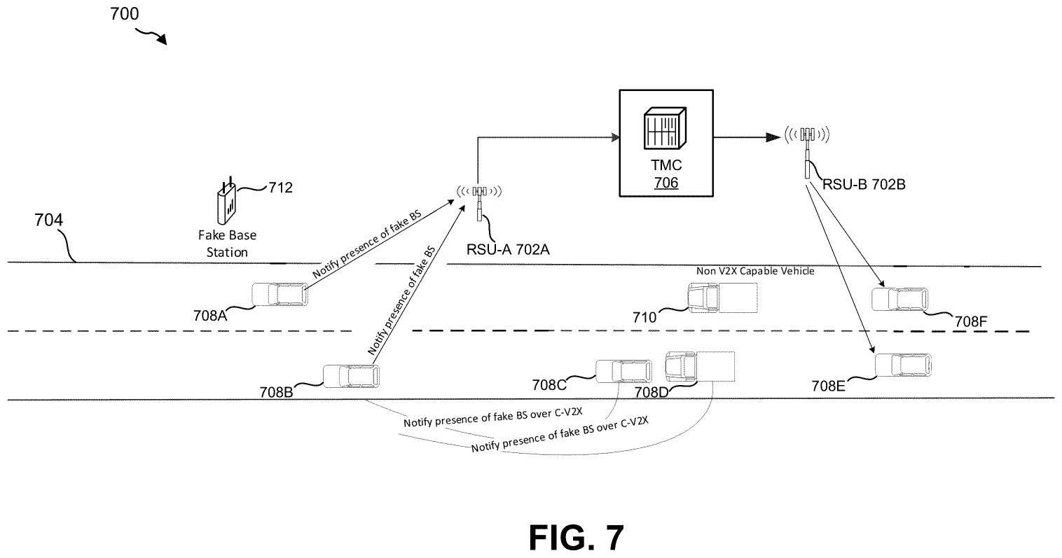

FIG. 7 illustrates an example of a wireless network 700 performing a technique for enhanced V2X cybersecurity capabilities, in accordance with aspects of the present disclosure. In this example, wireless network 700 includes two RSUs, RSU-A 702A and RSU-B 702B (collectively RSUs 702) along a road 704. The RSUs 702 may communicate with a traffic management center (TMC) 706. The TMC 706 may collect and consolidate information from the RSUs 702 and coordinate with other components of a wider network, such as a core network (not shown) of a network provider. The RSUs 702 may also communicate with some user devices, such as V2X capable vehicles 708A-708F (collectively vehicles 708), on the road 704. In some cases, there may also be non-V2X capable vehicles 710 on the road 704.

In some cases, a V2X capable vehicle, such as vehicle 708A and vehicle 708B, may be capable of detecting possible OTA attacks (e.g., potential threats). For example, wireless transmissions from a fake base station 712 may be detected by vehicle 708A and vehicle 708B. In some cases, the vehicle 708A and vehicle 708B may generate threat reports based on detecting the fake base station 712 and broadcast (e.g., via DSRC, C-V2X, or other wireless transmission protocol) these threat reports. In some cases, the threat reports may be received by other devices that are within range of vehicles 708A and 708B. These devices may include other UEs, such as vehicles 708, and/or network nodes, such as RSU-A 702A. In some cases, the threat reports may include a time and location information for when the transmission from the fake base station 712 was detected, along with information associated with the detected potential threat, such as an indication of a threat detected, base station identifier associated with the fake base station 712, threat score, confidence information, and the like.

In this example, host vehicles 708C and 708D may also be within range of vehicle 708B and may receive the threat report broadcast by vehicle 708B. In some cases, a host vehicle may refer to a V2X capable vehicle which receives messages from another V2X capable vehicle. In some cases, a host vehicle (e.g., vehicles 708C and 708D) may not be capable of detecting potential OTA threats. In such a case, host vehicles (e.g., vehicles 708C and 708D) that are not capable of detecting potential OTA threats may take steps to mitigate potential OTA threats based on received threat reports (either from another vehicle, such as vehicle 708B, or from an RSU, such as RSU-B 702B). For example, the host vehicle (e.g., vehicles 708C and 708D) may, based on a received threat report, block the fake base station 712 (e.g., not respond to transmissions from the fake base station 712). In some cases, the threat report may include information associated with the detected threat, such as information about the threat (e.g., describing or characterizing the type of threat), location information of the threat, a time for which the threat was detected, etc. As an example, the host vehicle (e.g., vehicles 708C and 708D) may block the fake base station 712 based on a base station identifier from the information associated with the detected threat in the threat report. In some cases, blocking the fake base station 712 may be performed if the time the threat was detected is within a threshold time window of a current time (e.g., when the threat report was received) and/or if the host vehicle (e.g., vehicles 708C and 708D) is within a distance threshold of the location the threat was detected.

In some cases, if the host vehicle (e.g., vehicles 708C and 708D) is capable of detecting potential OTA threats, the host vehicle (e.g., vehicles 708C and 708D) may use the received threat reports to help host vehicle (e.g., vehicles 708C and 708D) threat reporting. The host vehicle may use information from the received threat report to help detect or determine whether a received wireless transmission includes a potential threat. For example, the host vehicle (e.g., vehicles 708C and/or 708D) may receive a threat report from vehicle 708B. The host vehicle (e.g., vehicles 708C and/or 708D) may use, for example, the location information, time the threat was detected, BS ID, or other information from the received threat report to help the host vehicle detect the fake base station 712 or determine that a received transmission is from the fake base station 712.

In some cases, the host vehicle may use information from the received threat report, such as the location information, time, and/or information about the detected threat, such as the BS ID, to help determine a confidence level (e.g., confidence information) for the host vehicle threat reporting. For example, the confidence level may indicate that a potential threat reported by another vehicle, such as vehicle 708B, was also detected by the host vehicle (e.g., vehicles 708C and/or 708D). The host vehicle (e.g., vehicles 708C and/or 708D) may generate a second threat report based on the received threat report and detected threat and send the second threat report to another host vehicle or a network node. If the host vehicle (e.g., vehicles 708C and/or 708D) does not detect the threat from the received threat report (e.g., based on the location information, time, etc.), then the host vehicle (e.g., vehicles 708C and/or 708D) may generate a second threat report with confidence information indicating that the host vehicle (e.g., vehicles 708C and 708D) received a threat report, but did not itself detect the threat. Similarly, if the host vehicle (e.g., vehicles 708C and/or 708D) did detect the threat from the received threat report, then the host vehicle may generate a second threat report with confidence information (e.g., a higher confidence value, flag, bit field value, etc.) indicating that the host vehicle received a threat report and detected the threat. In some cases, a threat score for a second report may be determined based on the received threat report and whether the host vehicle (e.g., vehicles 708C and 708D) detected the threat.

As another example, both vehicle 708A and vehicle 708B may be within range of an RSU, such as RSU-A 702A, and RSU-A 702A may receive the threat reports broadcast by vehicles 708A and 708B. In some cases, RSU-A 702A may receive the threat reports and transmit the threat reports to the TMC 706. In some cases, the RSU-A 702A may consolidate multiple threat reports received from vehicles 708, such as vehicles 708A and 708B, prior to sending the threat reports to the TMC 706. In some cases, the TMC 706 may consolidate and/or correlate threat reports received from one or more RSUs 702. The TMC 706 may determine one or more RSUs which are associated with vehicles that are headed in a direction of the detected threat, but not yet within range of the detected threat, such as RSU 702B. In some cases, the TMC 706 may determine the RSUs associated with vehicles headed in a direction of the detected threat based on location information from the threat reports. The TMC 706 may transmit the consolidated threat reports to the determined RSU, such as RSU 702B. After receiving the threat reports from the TMC 706, RSU 702B may then transmit the threat reports to those vehicles, such as vehicles 708E and 708F. In some cases, the RSU 702B may broadcast the threat reports, for example in a broadcast message. In other cases, the RSU 702B may transmit the threat reports to those vehicles headed in a direction of the detected threat, such as vehicles 708E and 708F. Vehicles 708E and 708F may then be able to take measures to mitigate the detected threat, for example by changing routes to avoid the location indicated in the threat report (e.g., associated with the potential threat), blocking a wireless station associated with potential threat (e.g., the fake base station 712), use the received threat report to help the threat reporting, or any other detection/mitigation technique.

In some cases, the TMC 706 may also forward threat reports on to the wider network. For example, the TMC 706 may forward the threat reports to a core network of a network provider or on to law enforcement. In some cases, the core network may indicate, to the TMC 706, that a potential threat may not be a valid threat, such as if the detected potential fake base station 712 is actually a newly installed base station. The TMC 706 may then indicate to the vehicles 708 that the potential fake base station 712 is not a threat.

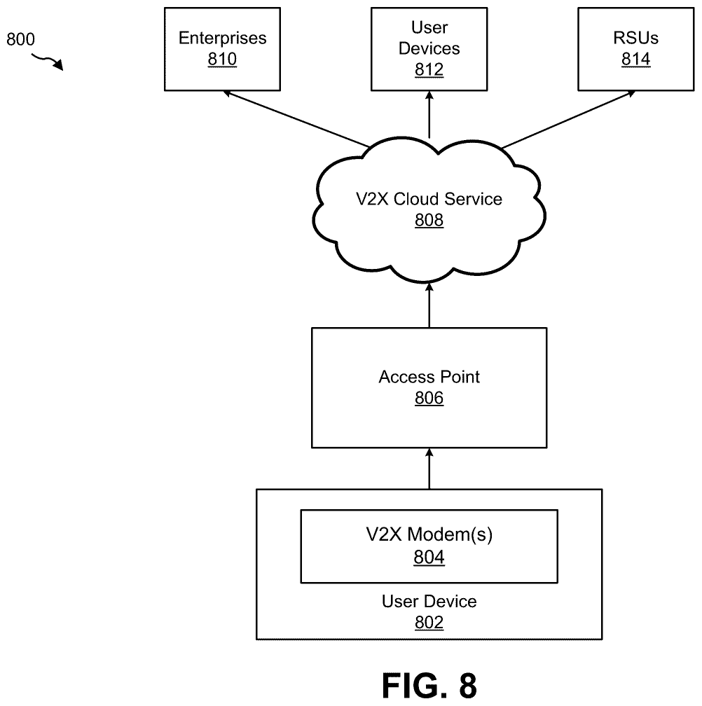

FIG. 8 illustrates an example topology of a network 800 for performing a technique for enhanced V2X cybersecurity capabilities, in accordance with aspects of the present disclosure. In some cases, threat reports may be sent to a cloud based V2X cloud service 808 operating separately from a wireless network provider. For example, V2X cloud service 808 may be hosted on the Internet rather than, for example, as a service operating on network operated by a wireless network provider (e.g., an RSU, TMC, BS, eNB, gNB, DU, CU, core network, or the like). As the V2X cloud service 808 operates separate from the wireless network provider, the V2X cloud service 808 may be accessible to users of different wireless network providers.

In network 800, a user device 802, such as a V2X capable vehicle, may include a V2X modem 804 capable of detecting possible OTA attacks and transmitting threat reports based on detected possible OTA attacks. In some cases, V2X modem 804 may be similar to modem 604 of FIG. 6. The user device 802 may transmit threat reports via access point 806 to a V2X cloud service 808. In some cases, the access point 806 may be associated with any RAT, such as Wi-Fi, 5G NR, LTE, or the like, through which the user device 802 may access Internet-based services. In some cases, threat reports may be received by the V2X cloud service 808. The V2X cloud service 808 may collect and consolidate threat reports from multiple user devices 802. For example, the V2X cloud service 808 may aggregate threat reports having a similar time and location for a potential threat and provide these consolidated threat reports to various parties. For example, the V2X cloud service 808 may provide the consolidated threat reports to various enterprises 810, such as wireless network operators, law enforcement, navigation services, and the like. The V2X cloud service 808 may also provide consolidated threat reports directly to other user devices 812 or RSUs 814. These threat reports may be used to alert over user devices or otherwise mitigate potential threats in a manner similar to that described above with respect to FIG. 6.

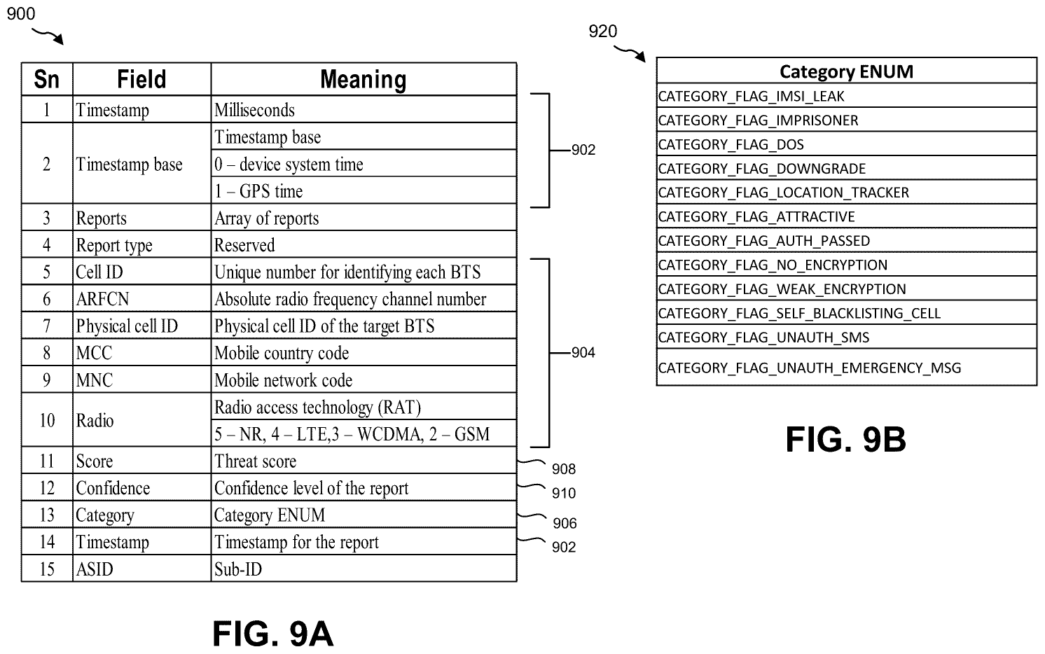

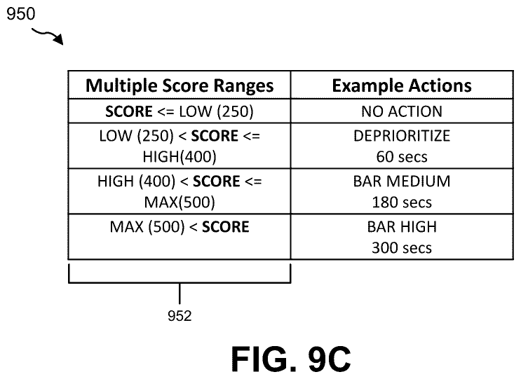

FIGS. 9A-9C illustrate details of an example threat report 900, in accordance with aspects of the present disclosure. In some cases, the threat report 900 (e.g., cyber_security_threat_report) may provide information about a detected potential threat such as a time 902 the threat was detected, location of the user device when the threat was detected, information about a base station 904 associated with the threat, category information 906 about the detected potential threat, a threat score 908 and confidence information 910. In some cases, the information about the base station 904 may include a base station identifier, a physical cell identifier, an absolute radio frequency channel number (ARFCN), a mobile country code, and a mobile network code, along with information about the type of RAT is in use.

In some cases, the category information 906 may indicate a type of potential threat that was detected and examples of types of potential threats are illustrated in FIG. 9B. In some cases, the types of potential threats may be from a predefined enumerated list of possible threats 920.

In some cases, the confidence information 910 may be based on how the potential threat was detected and/or whether there is corroborating evidence of the potential threat. For example, the confidence information 910 may indicate that the potential threat was locally detected. For example, the confidence information 910 may be two or three bit values that indicate whether the potential threat was detected locally, whether the potential threat was indicated, for example, in a received threat report (e.g., as described above with respect to vehicles 708C, 708D, 708E, and 708F of FIG. 7), or both.

In some cases, a threat score 908 may be provided. In some cases, the threat score 908 may be based on how well the detected potential threat matches with features indicative of a threat of the category associated with the detected potential threat. For example, certain threat categories may be associated with certain indicative features, and a potential threat (e.g., potential OTA attack) may be compared to such indicative features to determine the threat score 908. In some cases, the threat score 908 may be adjusted if there was a corroborating threat report received (e.g., from another user device, RSU, V2X service, etc.).

In some cases, different mitigations may be implemented by a user device based on the threat score 908. FIG. 9C illustrates example actions that may be taken based on threat scoring 950, in accordance with aspects of the present disclosure. As an example, if a threat score 952 is relatively low (e.g., below a low threat score threshold), no action may be taken. If the threat score 952 is medium (e.g., between a low threat score threshold and a high threat score threshold), the UE may deprioritize a wireless node associated with the threat (e.g., fake base station 712 od FIG. 7). If the threat score 952 is relatively high (e.g., above the high threat score threshold), then the UE may bar (e.g., block) the threat for a certain amount of time. In some cases, if the threat score 952 is maximized, then the UE may bar (e.g., block) the threat for a longer period of time.

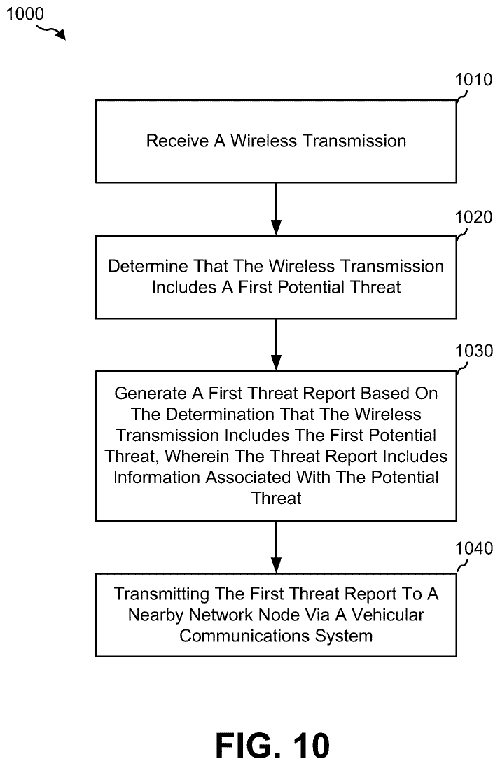

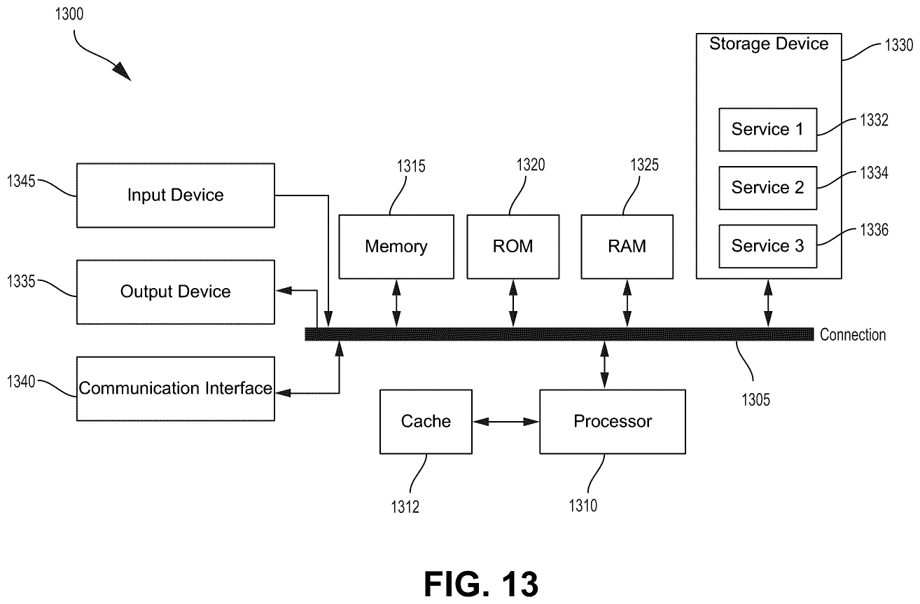

FIG. 10 is a flow diagram of a process 1000 for threat reporting for a wireless vehicular device configured to perform V2X communications (e.g., V2V communications, V2P communications, V2I communications, and/or other V2X communications), in accordance with aspects of the present disclosure. The process 1000 may be performed by a computing device (or apparatus) or a component (e.g., a chipset, codec, etc.) of the computing device. The computing device may be a mobile device (e.g., a user device), a UE (e.g., UE 104 of FIG. 1, UE 221 of FIG. 2, user device 507 of FIG. 5, user device 600 of FIG. 6, and/or user device 802 of FIG. 8), a vehicle (e.g., vehicle 304 of FIG. 3, vehicle 404 of FIG. 4, and/or vehicles 708 of FIG. 7) or component or system of a vehicle, or other type of computing device. The operations of the process 1000 may be implemented as software components that are executed and run on one or more processors (e.g., processor 584 of FIG. 5, and/or processor 1310 of FIG. 13). In some cases, the operations of the process 1000 can be implemented by a system having the architecture of computing system 1300 of FIG. 13.

At block 1010, the computing device (or component thereof) may receive a wireless transmission (e.g., via a. In some cases, the computing device (or component thereof) may receive a broadcast message from a wireless vehicular device via a vehicular communications system (e.g., a vehicular communication network). The wireless vehicular device is configured to perform V2X communications, such as V2V communications, V2P communications, V2I communications, and/or other V2X communications. The broadcast message includes a second threat report. In some cases, the first threat report is generated based on the second threat report. In some cases, the second threat report includes information associated with a second potential threat. In some cases, the computing device (or component thereof) may mitigate the second potential threat based on the information associated with the second potential threat. In some aspects, the computing device (or component thereof) may mitigate the second potential threat by changing a route of the computing device to avoid a location associated with the second potential threat; blocking a wireless station associated with the second potential threat; or determining the wireless transmission includes the first potential threat based at least in part on the information associated with the second potential threat.

At block 1020, the computing device (or component thereof) may determine that the wireless transmission includes a first potential threat. For example, a vehicular device may include threat detection and mitigation/countermeasure systems for a RAT (e.g., WWAN network node such as rogue base station, DOS attack, jamming attack for the mobile network operator or MNO on which the vehicular device is registered), Wi-Fi threats, GNSS threats (jamming) etc.).

At block 1030, the computing device (or component thereof) may generate a first threat report based on the determination that the wireless transmission includes the first potential threat, wherein the first threat report includes information associated with the first potential threat. In some aspects, the first threat report includes location information for the apparatus and a time associated with the first potential threat. In some cases, the first threat report is transmitted as a part of another message. In some aspects, the first threat report includes confidence information. In some cases, the confidence information indicates at least one of: the apparatus determined that the received wireless transmission included the first potential threat; or the apparatus received a second threat report, the second threat report including an indication of the first potential threat. In some aspects, the first threat report includes a threat score.

At block 1040, the computing device (or component thereof) may transmit the first threat report to a network node (e.g., a nearby network node) via the vehicular communications system. In some cases, the computing device (or component thereof) may transmit the first threat report by broadcasting the first threat report via the vehicular communications system. In some aspects, the computing device (or component thereof) may transmit the first threat report by transmitting the first threat report to an internet-based service.

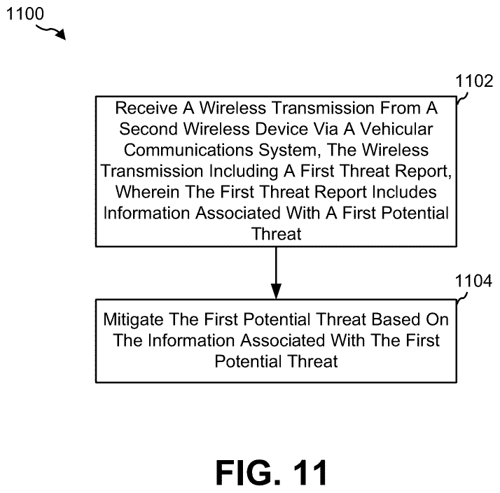

FIG. 11 is a flow diagram of a process 1100 for threat reporting for a wireless device, in accordance with aspects of the present disclosure. The process 1100 may be performed by a computing device (or apparatus) or a component (e.g., a chipset, codec, etc.) of the computing device. The computing device may be a mobile device (e.g., a user device), a UE (e.g., UE 104 of FIG. 1, UE 221 of FIG. 2, user device 507 of FIG. 5, user device 600 of FIG. 6, and/or user device 802 of FIG. 8), a vehicle (e.g., vehicle 304 of FIG. 3, vehicle 404 of FIG. 4, and/or vehicles 708 of FIG. 7) or component or system of a vehicle, or other type of computing device. The operations of the process 1100 may be implemented as software components that are executed and run on one or more processors (e.g., processor 584 of FIG. 5, and/or processor 1310 of FIG. 13). In some cases, the operations of the process 1100 can be implemented by a system having the architecture of computing system 1300 of FIG. 13.

At block 1110, the computing device (or component thereof) may receive a wireless transmission from a second wireless vehicular device (e.g., vehicle 708C may receive a wireless transmission from vehicle 708B) via a vehicular communication network, the wireless transmission including a first threat report (e.g., threat report 900), where the first threat report includes information associated with a first potential threat. In some cases, the wireless transmission is a broadcast transmission via the vehicular communication network.

At block 1112, the computing device (or component thereof) may mitigate the first potential threat based on the information associated with the first potential threat. In some cases, the computing device (or component thereof) may not be configured to determine whether a received wireless transmission includes a potential threat. In some cases, the computing device (or component thereof) may generate a second threat report based on the first threat report, the second threat report indicating that the first potential threat was in a received threat report. In some cases, the computing device (or component thereof) may transmit the second threat report to a network node of the vehicular communication network. In some cases, the computing device (or component thereof) may generate confidence information, wherein the second threat report includes the confidence information (e.g., confidence information 910 of FIG. 9A), wherein the confidence information indicates that the first potential threat was in a received threat report. For example, the confidence information may be three bit values that indicate whether the potential threat was detected locally, whether the potential threat was indicated, for example, in a received threat report. In some cases, mitigating the first potential threat includes at least one of: changing a route of a first wireless vehicular device to avoid a location associated with the first potential threat; and blocking a wireless station associated with the first potential threat. In some cases, the wireless transmission is received from a network node (e.g., RSU-B 702B) of the vehicular communication network.

In some cases, the computing device (or component thereof) the computing device (or component thereof) is configured to determine whether a received wireless transmission includes a potential threat and the computing device (or component thereof) may mitigate the first potential threat by receiving a second wireless transmission and determining the second wireless transmission includes the first potential threat based at least in part on the first threat report. For example, vehicle 708C of FIG. 7 may receive a threat report about fake base station 712 from another vehicle and the vehicle 708C may receive wireless transmissions from fake base station 712. In some cases, the computing device (or component thereof) may generate a second threat report based on the determination that the second wireless transmission includes the first potential threat and the first threat report and transmit the second threat report. In some cases, the computing device (or component thereof) may generate confidence information, wherein the second threat report includes the confidence information, and the confidence information indicates that: the first potential threat was in a received threat report and that the first potential threat was determined to be in a received wireless transmission. In some cases, the second threat report includes a threat score (e.g., threat score 908 of FIG. 9A). In some cases, the threat score is determined based on the determination that the second wireless transmission includes the first potential threat and the first threat report. In some cases, transmitting the second threat report comprises broadcasting the second threat report. In some cases, transmitting the second threat report comprises transmitting the second threat report to a network node of the vehicular communication network.

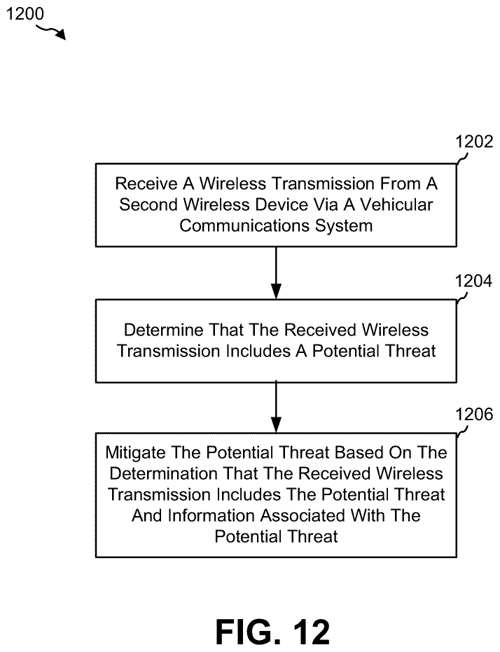

FIG. 12 is a flow diagram of a process 1200 for threat detection for a wireless device, in accordance with aspects of the present disclosure. The process 1200 may be performed by a computing device (or apparatus) or a component (e.g., a chipset, codec, etc.) of the computing device. The computing device may be a mobile device (e.g., a user device), a UE (e.g., UE 104 of FIG. 1, UE 221 of FIG. 2, user device 507 of FIG. 5, user device 600 of FIG. 6, and/or user device 802 of FIG. 8), a vehicle (e.g., vehicle 304 of FIG. 3, vehicle 404 of FIG. 4, and/or vehicles 708 of FIG. 7) or component or system of a vehicle, or other type of computing device. The operations of the process 1200 may be implemented as software components that are executed and run on one or more processors (e.g., processor 584 of FIG. 5, and/or processor 1310 of FIG. 13). In some cases, the operations of the process 1200 can be implemented by a system having the architecture of computing system 1300 of FIG. 13.

At block 1202, the computing device (or component thereof) may receive a wireless transmission from a second wireless vehicular device via a vehicular communication network. In some cases, the wireless transmission includes a first threat report, wherein the first threat report includes information associated with a potential threat. In some examples, the wireless transmission comprises a broadcast transmission.

At block 1204, the computing device (or component thereof) may determine that the received wireless transmission includes a potential threat. In some cases, the determination that the received wireless transmission is based on a security detection procedure for detecting potential threats in wireless transmissions.

At block 1206, the computing device (or component thereof) may mitigate the potential threat based on the determination that the received wireless transmission includes the potential threat and information associated with the potential threat. In some examples, the computing device (or component thereof) may generate a second threat report based on the first threat report, the second threat report indicating that the potential threat was in the first threat report and transmit the second threat report to a network node of the vehicular communication network. In some cases, the computing device (or component thereof) may mitigate the potential threat based on the determination that the received wireless transmission includes the potential threat and information associated with the potential threat by generating confidence information, wherein the second threat report includes the confidence information, and wherein the confidence information indicates that the potential threat was in a received threat report and in a received wireless transmission. In some examples, the computing device (or component thereof) may mitigate the potential threat by at least one of changing a route of a first wireless vehicular device to avoid a location associated with the first potential threat or blocking a wireless station associated with the first potential threat. In some cases, the computing device (or component thereof) may mitigate the potential threat by receiving a second wireless transmission and determining the second wireless transmission includes the potential threat based at least in part on the first threat report. In some examples, the computing device (or component thereof) may generate a second threat report based on the determination that the second wireless transmission includes the first potential threat and the first threat report and transmit the second threat report. In some cases, the computing device (or component thereof) may generate confidence information, wherein the second threat report includes the confidence information, and wherein the confidence information indicates that: the first potential threat was in a received threat report, and the first potential threat was determined to be in a received wireless transmission. In some examples, the second threat report includes a threat score. In some cases, the computing device (or component thereof) may to transmit the second threat report by broadcasting the second threat report via the vehicular communication network. In some examples, the computing device (or component thereof) may transmit the second threat report to a network node of the vehicular communication network.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 1000, 1100, 1200, and/or other processes described herein may include a processor, microprocessor, micro-computer, or other component of a device that is configured to carry out the steps of the process 1000, 1100, 1200, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1000, 1100, 1200, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1000, process 1100 and process 1200 are illustrated as a logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1000, 1100, 1200, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be employed by the disclosed V2X-sensor misbehavior detection system, in accordance with some aspects of the present disclosure. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LIDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method for threat reporting by a first wireless vehicular device, the method comprising: receiving a wireless transmission; determining that the wireless transmission includes a first potential threat; generating a first threat report based on the determination that the wireless transmission includes the first potential threat, wherein the first threat report includes information associated with the first potential threat; and transmitting the first threat report to a network node (e.g., a nearby network node) via a vehicular communications system.

Aspect 2. The method of Aspect 1, wherein the first threat report includes location information for the first wireless device and a time associated with the first potential threat.

Aspect 3. The method of any one of Aspects 1 or 2, wherein the first threat report is transmitted as a part of another message.

Aspect 4. The method of any one of Aspects 1 to 3, wherein the first threat report includes confidence information.

Aspect 5. The method of Aspect 4, wherein the confidence information indicates at least one of: the first wireless device determined that the received wireless transmission included the first potential threat; or the first wireless device received a second threat report, the second threat report including an indication of the first potential threat.

Aspect 6. The method of any one of Aspects 1 to 5, wherein the first threat report includes a threat score.

Aspect 7. The method of any one of Aspects 1 to 6, wherein transmitting the first threat report comprises broadcasting the first threat report via the vehicular communications system.

Aspect 8. The method of any one of Aspects 1 to 7, wherein transmitting the first threat report comprises transmitting the first threat report to an internet-based service.

Aspect 9. The method of any one of Aspects 1 to 8, further comprising: receiving a broadcast message from a second wireless device, the broadcast message including a second threat report, and wherein the first threat report is generated based on the second threat report.

Aspect 10. The method of Aspect 9, wherein the second threat report including information associated with a second potential threat, and further comprising mitigating the second potential threat based on the information associated with the second potential threat.

Aspect 11. The method of Aspect 10, wherein mitigating the second potential threat comprises at least one of: changing a route of the first wireless device to avoid a location associated with the second potential threat; blocking a wireless station associated with the second potential threat; and determining the wireless transmission includes the first potential threat based at least in part on the information associated with the second potential threat.

Aspect 12. An vehicular apparatus for threat detection, the apparatus comprising: a memory; and a processor coupled to the memory and configured to: receive a wireless transmission; determine that the wireless transmission includes a first potential threat; generate a first threat report based on the determination that the wireless transmission includes the first potential threat, wherein the first threat report includes information associated with the first potential threat; and transmit the first threat report to a nearby network node via the vehicular communications system.

Aspect 13. The vehicular apparatus of Aspect 12, wherein the first threat report includes location information for the vehicular apparatus and a time associated with the first potential threat.

Aspect 14. The vehicular apparatus of any one of Aspects 12 or 13, wherein the first threat report is transmitted as a part of another message.

Aspect 15. vehicular The apparatus of any one of Aspects 12 to 14, wherein the first threat report includes confidence information.

Aspect 16. The vehicular apparatus of Aspect 15, wherein the confidence information indicates at least one of: the vehicular apparatus determined that the received wireless transmission included the first potential threat; or the vehicular apparatus received a second threat report, the second threat report including an indication of the first potential threat.

Aspect 17. The vehicular apparatus of any one of Aspects 12 to 16, wherein the first threat report includes a threat score.

Aspect 18. The vehicular apparatus of any one of Aspects 12 to 17, wherein, to transmit the first threat report, the processor is configured to broadcast the first threat report via the vehicular communications system.

Aspect 19. The vehicular apparatus of any one of Aspects 12 to 18, wherein, to transmit the first threat report, the processor is configured to transmit the first threat report to an internet-based service.

Aspect 20. The vehicular apparatus of any one of Aspects 12 to 19, wherein the processor is further configured to receive a broadcast message from a wireless device, the broadcast message including a second threat report, and wherein the first threat report is generated based on the second threat report.

Aspect 21. The vehicular apparatus of Aspect 20, wherein the second threat report including information associated with a second potential threat, and wherein the processor is further configured to mitigate the second potential threat based on the information associated with the second potential threat.

Aspect 22. The vehicular apparatus of Aspect 21, wherein, to mitigate the second potential threat, the processor is configured to: change a route of the apparatus to avoid a location associated with the second potential threat; block a wireless station associated with the second potential threat; and determine the wireless transmission includes the first potential threat based at least in part on the information associated with the second potential threat.

Aspect 23. A non-transitory computer-readable medium having stored thereon instructions that, when executed by a processor, cause the processor to: receive a wireless transmission; determine that the wireless transmission includes a first potential threat; generate a first threat report based on the determination that the wireless transmission includes the first potential threat, wherein the first threat report includes information associated with the first potential threat; and transmit the first threat report to a nearby network node via a vehicular communications system.

Aspect 24. The non-transitory computer-readable medium of Aspect 23, wherein the first threat report includes location information for a first wireless device and a time associated with the first potential threat.

Aspect 25. The non-transitory computer-readable medium of any one of Aspects 23 or 24, wherein the first threat report is transmitted as a part of another message.

Aspect 26. The non-transitory computer-readable medium of any one of Aspects 23 to 25, wherein the first threat report includes confidence information.

Aspect 27. The non-transitory computer-readable medium of Aspect 26, wherein the confidence information indicates at least one of: a first wireless device determined that the received wireless transmission included the first potential threat; or a first wireless device received a second threat report, the second threat report including an indication of the first potential threat.

Aspect 28. The non-transitory computer-readable medium of any one of Aspects 23 to 27, wherein the first threat report includes a threat score.

Aspect 29. The non-transitory computer-readable medium of any one of Aspects 23 to 28, wherein, to transmit the first threat report, the instructions cause the processor to broadcast the first threat report via the vehicular communications system.

Aspect 30. The non-transitory computer-readable medium of any one of Aspects 23 to 29, wherein, to transmit the first threat report, the instructions cause the processor to transmit the first threat report to an internet-based service.

Aspect 31. The non-transitory computer-readable medium of any one of Aspects 23 to 30, wherein the instructions further cause the processor to receive a broadcast message from a second wireless device, the broadcast message including a second threat report, and wherein the first threat report is generated based on the second threat report.

Aspect 32. The non-transitory computer-readable medium of Aspect 31, wherein the second threat report including information associated with a second potential threat, and the instructions further cause the processor to mitigate the second potential threat based on the information associated with the second potential threat.

Aspect 33. The non-transitory computer-readable medium of Aspect 32, wherein, to mitigate the second potential threat, the instructions cause the processor to: change a route of a first wireless device to avoid a location associated with the second potential threat; block a wireless station associated with the second potential threat; and determine the wireless transmission includes the first potential threat based at least in part on the information associated with the second potential threat.

Aspect 34. A method for threat mitigation by a first wireless vehicular device, the method comprising: receiving a threat report from a network node via a vehicular communications system, wherein the threat report includes information associated with a potential threat, and wherein the network node generates the threat report based on a security detection procedure; and mitigating, by the wireless device, the potential threat based on the information associated with the potential threat without performing the security detection procedure.

Aspect 35. The method of Aspect 34, wherein mitigating the potential threat comprises: changing a route of the first wireless vehicular device to avoid a location associated with the potential threat; and blocking a wireless station associated with the potential threat.

Aspect 36. A method for threat detection by a first wireless device comprising: receiving a wireless transmission from a second wireless vehicular device via the vehicular communications system, the wireless transmission including a threat report, wherein the threat report includes information associated with a potential threat; determine that the received wireless transmission includes a potential threat; and mitigating the potential threat based on the determination that the received wireless transmission includes the potential threat and information associated with the potential threat.

Aspect 37. The method of Aspect 36, wherein the wireless transmission comprises a broadcast transmission.

Aspect 38. The method of any one of Aspects 36 or 37, further comprising generating a second threat report based on the first threat report, the second threat report indicating that the first potential threat was in a received threat report; and transmitting the second threat report to a network node of the vehicular communications system.

Aspect 39. The method of Aspect 38, wherein mitigating the potential threat based on the determination that the received wireless transmission includes the potential threat and information associated with the potential threat comprises generating confidence information, wherein the second threat report includes the confidence information, and wherein the confidence information indicates that the first potential threat was in a received threat report and in a received wireless transmission.

Aspect 40. The method of any one of Aspects 36 to 39, wherein mitigating the first potential threat comprises at least one of: changing a route of a first wireless vehicular device to avoid a location associated with the first potential threat; and blocking a wireless station associated with the first potential threat.

Aspect 41. The method of any one of Aspects 36 to 40, wherein mitigating the first potential threat comprises: receiving a second wireless transmission; and determining the second wireless transmission includes the first potential threat based at least in part on the first threat report.

Aspect 42. The method of Aspect 41, further comprising: generating a second threat report based on the determination that the second wireless transmission includes the first potential threat and the first threat report; and transmitting the second threat report via the vehicular communications system.

Aspect 43. The method of Aspect 42, further comprising generating confidence information, wherein the second threat report includes the confidence information, and wherein the confidence information indicates that the first potential threat was in a received threat report and that the first potential threat was determined to be in a received wireless transmission.

Aspect 44. The method of any one of Aspects 42 or 43, wherein the second threat report includes a threat score.

Aspect 45. The method of Aspect 44, wherein the threat score is determined based on the determination that the second wireless transmission includes the first potential threat and the first threat report.

Aspect 46. The method of any one of Aspects 42 to 45, wherein transmitting the second threat report comprises broadcasting the second threat report.

Aspect 47. The method of any one of Aspects 42 to 46, wherein transmitting the second threat report comprises transmitting the second threat report to a network node of the vehicular communications system.

Aspect 48: The method of any one of Aspects 34-35, wherein the first wireless vehicular device is not configured to determine whether a received wireless transmission includes a potential threat.

Aspect 49: The method of Aspect 34-35, wherein the wireless transmission is received from a network node of the vehicular communications system.

Aspect 50: A non-transitory computer-readable storage medium comprising instructions stored thereon which, when executed by one or more processors, cause the one or more processors to perform operations according to any of Aspects 1 to 11.

Aspect 51: A vehicular apparatus for wireless communications, comprising one or more means for performing operations according to any of Aspects 1 to 11.

Aspect 52: A vehicular apparatus for threat mitigation, comprising a memory and a processor coupled to the memory and configured to perform operations according to any of Aspects 34-47.

Aspect 53: A non-transitory computer-readable storage medium comprising instructions stored thereon which, when executed by one or more processors, cause the one or more processors to perform operations according to any of aspects 34-47.

Aspect 54: A vehicular apparatus for wireless communications, comprising one or more means for performing operations according to any of aspects 34-47.

Aspect 55: The method of Aspect 36, wherein the determination that the received wireless transmission is based on a security detection procedure for detecting potential threats in wireless transmissions.

Aspect 56. The method of Aspect 34, wherein the security detection procedure comprises a process for detecting potential threats in a wireless transmission.

Aspect 57. The method of Aspect 34, wherein the wireless vehicular device is not configured to be able to perform the security detection procedure.

Aspect 61. A vehicular apparatus for threat detection, the vehicular apparatus comprising: a memory; and a processor coupled to the memory and configured to: receive a wireless transmission; determine that the wireless transmission includes a first potential threat; generate a first threat report based on the determination that the wireless transmission includes the first potential threat, wherein the first threat report includes information associated with the first potential threat; and transmit the first threat report to a nearby network node via a vehicular communications system.

Aspect 62. The vehicular apparatus of aspect 61, wherein the first threat report includes location information for the apparatus and a time associated with the first potential threat.

Aspect 63. The vehicular apparatus of aspect 61, wherein the first threat report is transmitted as a part of another message.

Aspect 64. The vehicular apparatus of aspect 61, wherein the first threat report includes confidence information.

Aspect 65. The vehicular apparatus of aspect 64, wherein the confidence information indicates at least one of: the apparatus determined that the received wireless transmission included the first potential threat; or the apparatus received a second threat report, the second threat report including an indication of the first potential threat.

Aspect 66. The vehicular apparatus of aspect 61, wherein the first threat report includes a threat score.

Aspect 67. The vehicular apparatus of aspect 61, wherein, to transmit the first threat report, the processor is configured to broadcast the first threat report via the vehicular communications system.

Aspect 68. The vehicular apparatus of aspect 61, wherein, to transmit the first threat report, the processor is configured to transmit the first threat report to an internet-based service.

Aspect 69. The vehicular apparatus of aspect 61, wherein the processor is further configured to receive a broadcast message from a wireless device, the broadcast message including a second threat report, and wherein the first threat report is generated based on the second threat report.

Aspect 70. The vehicular apparatus of aspect 69, wherein the second threat report including information associated with a second potential threat, and wherein the processor is further configured to mitigate the second potential threat based on the information associated with the second potential threat.

Aspect 71. The vehicular apparatus of aspect 70, wherein, to mitigate the second potential threat, the processor is configured to: change a route of the vehicular apparatus to avoid a location associated with the second potential threat; block a wireless station associated with the second potential threat; and determine the wireless transmission includes the first potential threat based at least in part on the information associated with the second potential threat.

Aspect 72. An wireless vehicular device for threat mitigation, the wireless vehicular device comprising: a memory; and a processor coupled to the memory and configured to: receive a threat report from a network node of a vehicular communications system, wherein the threat report includes information associated with a first potential threat, and wherein the network node generates the threat report based on a security detection procedure; and mitigate the potential threat based on the information associated with the potential threat without performing the security detection procedure.

Aspect 73. The wireless vehicular device of aspect 72, wherein, to mitigate the potential threat, the processor is configured to: change a route of the wireless vehicular device to avoid a location associated with the potential threat; and block a wireless station associated with the potential threat.

Aspect 74. The wireless vehicular device of aspect 72, wherein the security detection procedure comprises a process for detecting potential threats in a wireless transmission.

Aspect 75. The wireless vehicular device of aspect 72, wherein the wireless vehicular device is not configured to be able to perform the security detection procedure.

Aspect 76. An wireless vehicular device for threat detection comprising: a memory; and a processor coupled to the memory and configured to: receive a wireless transmission from a second wireless device via a vehicular communications system, the wireless transmission including a first threat report, wherein the threat report includes information associated with a potential threat; determine that the received wireless transmission includes a potential threat; and mitigate the potential threat based on the determination that the received wireless transmission includes the potential threat and information associated with the potential threat.

Aspect 77. The wireless device of aspect 76, wherein the wireless transmission comprises a broadcast transmission.

Aspect 78. The wireless device of aspect 76, wherein the processor is further configured to: generate a second threat report based on the first threat report, the second threat report indicating that the potential threat was in the first threat report; and transmit the second threat report to a network node of the vehicular communications system.

Aspect 79. The wireless vehicular device of aspect 78, wherein, to mitigate the potential threat based on the determination that the received wireless transmission includes the potential threat and information associated with the potential threat, the processor is configured to generate confidence information, wherein the second threat report includes the confidence information, and wherein the confidence information indicates that the potential threat was in a received threat report and in a received wireless transmission.

Aspect 80. The wireless vehicular device of aspect 76, wherein, to mitigate the potential threat, the processor is configured to perform at least one of: changing a route of a first wireless vehicular device to avoid a location associated with the first potential threat; and blocking a wireless station associated with the first potential threat.

Aspect 81. The wireless vehicular device of aspect 76, wherein, to mitigate the potential threat, the processor is further configured to: receive a second wireless transmission; and determine the second wireless transmission includes the potential threat based at least in part on the first threat report.

Aspect 82. The wireless vehicular device of aspect 81, wherein the processor is further configured to: generate a second threat report based on the determination that the second wireless transmission includes the first potential threat and the first threat report; and transmit the second threat report via the vehicular communications system.

Aspect 83. The wireless vehicular device of aspect 82, wherein the processor is further configured to generate confidence information, wherein the second threat report includes the confidence information, and wherein the confidence information indicates that: the first potential threat was in a received threat report, and the first potential threat was determined to be in a received wireless transmission.

Aspect 84. The wireless vehicular device of aspect 82, wherein the second threat report includes a threat score.

Aspect 85. The wireless vehicular device of aspect 84, wherein the threat score is determined based on the determination that the second wireless transmission includes the first potential threat and the first threat report.

Aspect 86. The wireless vehicular device of aspect 82, wherein, to transmit the second threat report, the at least one processor is configured to broadcast the second threat report.

Aspect 87. The wireless vehicular device of aspect 82, wherein, to transmit the second threat report, the at least one processor is configured to transmit the second threat report to a network node of the vehicular communications system.

Aspect 88. The wireless vehicular device of aspect 86, wherein the determination that the received wireless transmission is based on a security detection procedure for detecting potential threats in wireless transmissions.

Aspect 89. A method for threat reporting by a first wireless vehicular device, the method comprising: receiving a wireless transmission; determining thatv the wireless transmission includes a first potential threat; generating a first threat report based on the determination that the wireless transmission includes the first potential threat, wherein the first threat report includes information associated with the first potential threat; and transmitting the first threat report to a nearby network node via a vehicular communications system.

Aspect 90. The method of aspect 89, wherein the first threat report includes location information for the first wireless vehicular device and a time associated with the first potential threat.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A vehicular apparatus for threat detection, the vehicular apparatus comprising:
a memory; and
a processor coupled to the memory and configured to:
receive a wireless transmission;
determine that the wireless transmission includes a first potential threat;
generate a first threat report based on the determination that the wireless transmission includes the first potential threat, wherein the first threat report includes information associated with the first potential threat; and
transmit the first threat report to a network node via a vehicular communications system.

2. The vehicular apparatus of claim 1, wherein the first threat report includes location information for the vehicular apparatus and a time associated with the first potential threat.

3. The vehicular apparatus of claim 1, wherein the first threat report is transmitted as a part of another message.

4. The vehicular apparatus of claim 1, wherein the first threat report includes confidence information.

5. The vehicular apparatus of claim 4, wherein the confidence information indicates at least one of:
the vehicular apparatus determined that the received wireless transmission included the first potential threat; or
the vehicular apparatus received a second threat report, the second threat report including an indication of the first potential threat.

6. The vehicular apparatus of claim 1, wherein the first threat report includes a threat score.

7. The vehicular apparatus of claim 1, wherein, to transmit the first threat report, the processor is configured to broadcast the first threat report via the vehicular communications system.

8. The vehicular apparatus of claim 1, wherein, to transmit the first threat report, the processor is configured to transmit the first threat report to an internet-based service.

9. The vehicular apparatus of claim 1, wherein the processor is further configured to receive a broadcast message from a wireless device, the broadcast message including a second threat report, and wherein the first threat report is generated based on the second threat report.

10. The vehicular apparatus of claim 9, wherein the second threat report including information associated with a second potential threat, and wherein the processor is further configured to mitigate the second potential threat based on the information associated with the second potential threat.

11. The vehicular apparatus of claim 10, wherein, to mitigate the second potential threat, the processor is configured to:
change a route of the vehicular apparatus to avoid a location associated with the second potential threat;
block a wireless station associated with the second potential threat; and
determine the wireless transmission includes the first potential threat based at least in part on the information associated with the second potential threat.

12. A wireless vehicular device for threat mitigation, the wireless vehicular device comprising:
a memory; and
a processor coupled to the memory and configured to:
receive a threat report from a network node via a vehicular communications system, wherein the threat report includes information associated with a potential threat, and wherein the network node generates the threat report based on a security detection procedure; and
mitigate the potential threat based on the information associated with the potential threat without performing the security detection procedure.

13. The wireless vehicular device of claim 12, wherein, to mitigate the potential threat, the processor is configured to:
change a route of the wireless vehicular device to avoid a location associated with the potential threat; and
block a wireless station associated with the potential threat.

14. The wireless vehicular device of claim 12, wherein the security detection procedure comprises a process for detecting potential threats in a wireless transmission.

15. The wireless vehicular device of claim 12, wherein the wireless vehicular device is not configured to be able to perform the security detection procedure.

16. A wireless vehicular device for threat detection comprising:
a memory; and
a processor coupled to the memory and configured to:
receive a wireless transmission from a second wireless device via a vehicular communications system, the wireless transmission including a first threat report, wherein the first threat report includes information associated with a potential threat;
determine that the received wireless transmission includes a potential threat; and
mitigate the potential threat based on the determination that the received wireless transmission includes the potential threat and information associated with the potential threat.

17. The wireless vehicular device of claim 16, wherein the wireless transmission comprises a broadcast transmission.

18. The wireless vehicular device of claim 16, wherein the processor is further configured to:
generate a second threat report based on the first threat report, the second threat report indicating that the potential threat was in the first threat report; and
transmit the second threat report to a network node via the vehicular communications system.

19. The wireless vehicular device of claim 18, wherein, to mitigate the potential threat based on the determination that the received wireless transmission includes the potential threat and information associated with the potential threat, the processor is configured to generate confidence information, wherein the second threat report includes the confidence information, and wherein the confidence information indicates that the potential threat was in a received threat report and in a received wireless transmission.

20. The wireless vehicular device of claim 16, wherein, to mitigate the potential threat, the processor is configured to perform at least one of:
changing a route of a first wireless device to avoid a location associated with the potential threat; and
blocking a wireless station associated with the potential threat.

21. The wireless vehicular device of claim 16, wherein, to mitigate the potential threat, the processor is further configured to:
receive a second wireless transmission via the vehicular communications system; and
determine the second wireless transmission includes the potential threat based at least in part on the first threat report.

22. The wireless vehicular device of claim 21, wherein the processor is further configured to:
generate a second threat report based on the determination that the second wireless transmission includes the potential threat and the first threat report; and
transmit the second threat report via the vehicular communications system.

23. The wireless vehicular device of claim 22, wherein the processor is further configured to generate confidence information, wherein the second threat report includes the confidence information, and wherein the confidence information indicates that:
the potential threat was in a received threat report, and
the potential threat was determined to be in a received wireless transmission.

24. The wireless vehicular device of claim 22, wherein the second threat report includes a threat score.

25. The wireless vehicular device of claim 24, wherein the threat score is determined based on the determination that the second wireless transmission includes the potential threat and the first threat report.

26. The wireless vehicular device of claim 22, wherein, to transmit the second threat report, the processor is configured to broadcast the second threat report via the vehicular communications system.

27. The wireless vehicular device of claim 22, wherein, to transmit the second threat report, the processor is configured to transmit the second threat report to a network node of the vehicular communications system.

28. The wireless vehicular device of claim 16, wherein the determination that the received wireless transmission is based on a security detection procedure for detecting potential threats in wireless transmissions.

29. A method for threat reporting by a first wireless vehicular device, the method comprising:
receiving a wireless transmission;
determining the wireless transmission includes a potential threat;
generating a first threat report based on the determination that the wireless transmission includes the potential threat, wherein the first threat report includes information associated with the potential threat; and
transmitting, via a vehicular communications system, the first threat report to a network node of the vehicular communications system.

30. The method of claim 29, wherein the first threat report includes location information for the first wireless vehicular device and a time associated with the potential threat.
